(19) United States
(12) Patent Application Publication
(10) Pub. No.: US 2012/0120864 A1
(43) Pub. Date: May 17, 2012

(54) WIRELESS BASE STATION

(75) Inventor: Takeo Miyata, Daito-shi (JP)

(73) Assignee: KYOCERA CORPORATION, KYOTO-SHI, KYOTO (JP)

(21) Appl. No.: 13/387,251

(22) PCT Filed: Jul. 12, 2010
(86) PCT No.: PCT/JP2010/061752

§ 371 Date: Jan. 26, 2012

(30) Foreign Application Priority Data
Jul. 29, 2009 (JP) 2009-176510
Jul. 29, 2009 (JP) 2009-176511

(51) Int. Cl. H04W 72/04

(52) U.S. Cl. 370/312

(57) ABSTRACT

A mode setting unit sets two or more wireless terminals at a collaborative spatial multiplex mode in which the same uplink data burst region is shared for usage, based on the throughput of uplink signals from a plurality of wireless terminals. A burst region notification unit notifies the two or more wireless terminals set at the collaborative spatial multiplex mode of the uplink data burst region shared between the two or more wireless terminals for usage. A switching unit switches, for a first type of wireless terminal transmitting a known signal from a plurality of antennas, the MIMO scheme of a downlink signal from the space-time coding type to the spatial multiplex type when a predetermined condition for communication quality and spatial correlation coefficient satisfy a predetermined condition.

### TECHNICAL FIELD

The present invention relates to wireless base stations, particularly a wireless base station performing wireless communication using a plurality of antennas.

### BACKGROUND ART

In various wireless communication systems such as WiMAX (Worldwide Interoperability for Microwave Access), next-generation PHS (Personal Handy-Phone System), LTE (Long Term Evolution), and the like, the communication technology of MIMO (Multiple Input Multiple Output) utilizing a plurality of antennas at both the transmitting side and receiving side is employed for the purpose of improving the throughput and frequency usage efficiency (for example, refer to Patent Literature 1 (Japanese Patent Laying-Open No. 2006-121703)).

The MIMO employed in the communication scheme between a wireless terminal and a wireless base station typically includes the STC (Space-Time Coding)-based type and the SM (Spatial Multiplex)-based type.

In the STC-based type, one signal stream is aligned (i.e. coded) based on a certain rule about time and space (antenna), and the coded signal bit stream is transmitted from a plurality of antennas. In WiMAX, an STC-based downlink communication scheme is called “DL MIMO MATRIX-A”. However, in WiMAX, an STC-based uplink communication scheme is not supported as of now.

In contrast, in the SM-based type, a plurality of signal streams are multiplexed from a plurality of antennas at the same frequency. In WiMAX, an SM-based downlink communication scheme is called “DL-MIMO MATRIX-B”, whereas an SM-based uplink communication scheme is called collaborative spatial multiplex (collaborative SM).

### CITATION LIST

### Patent Literature

PTL 1: Japanese Patent Laying-Open No. 2006-121703

### SUMMARY OF INVENTION

### Technical Problem

With regards to collaborative spatial multiplex (collaborative SM) in the uplink communication scheme, what combination of wireless terminals for collaborative spatial multiplexing of uplink signals to a wireless base station is to be set for better reception performance at the wireless base station differs depending upon the state of the transmission path. Under existing circumstances, an appropriate method of setting the combination of wireless terminals for collaborative spatial multiplex according to the transmission path state is not established.

As to the downlink communication scheme, whether to use the MIMO scheme of the space-time coding type (DL MIMO MATRIX-A) or of the spatial multiplexing type (DL MIMO MATRIX-B) to improve the wireless terminal's throughput property and area property as well as frequency usage efficiency may differ depending on the transmission path state. Under existing circumstances, a method of appropriately switching between these communication schemes according to the transmission path state is not established.

In view of the foregoing, one object of the present invention is to provide a wireless base station that allows high reception performance to be achieved at a wireless base station by appropriately setting a combination of wireless terminals for collaborative spatial multiplex of uplink signals.

Another object of the present invention is to provide a wireless base station that allows high throughput property and area property as well as high frequency usage efficiency at a wireless terminal by appropriately switching the downlink signal MIMO scheme to the space-time coding type or the spatial multiplex type.

### Solution to Problem

The present invention is directed to a wireless base station communicating with a plurality of wireless terminals transmitting an uplink signal. The wireless base station includes a plurality of antennas; a mode setting unit setting two or more wireless terminals at a collaborative spatial multiplex mode in which an identical uplink data burst region is shared for usage, based on throughput of uplink signals from a plurality of wireless terminals; a region notification unit notifying the two or more wireless terminals set at the collaborative spatial multiplex mode of the uplink data burst region shared among two or more wireless terminals for usage; and a reception unit separating uplink signals received through the plurality of antennas and spatial multiplexed at the shared uplink data burst region from the two or more wireless terminals set at the collaborative spatial multiplex mode to extract a signal from each wireless terminal.

Preferably, the mode setting unit includes a candidate selection unit selecting a candidate terminal from a plurality of wireless terminals that becomes a candidate for being set at the collaborative spatial multiplex mode, a throughput calculation unit establishing a pair from the selected candidate terminals and calculating the sum of throughput of uplink signals from all wireless terminals of the communication party when wireless terminals constituting a pair are set at the collaborative spatial multiplex mode, and a terminal setting unit identifying the pair that has the maximum sum of throughput calculated when set at the collaborative spatial multiplex mode, and setting the identified pair of wireless terminals at the collaborative spatial multiplex mode.

Preferably, the mode setting unit includes a candidate selection unit selecting a candidate terminal from the plurality of wireless terminals that becomes a candidate for being set at the collaborative spatial multiplex mode, a power control unit establishing a pair from the selected candidate terminals and instructing one or both of the wireless terminals constituting a pair to adjust transmission power such that a difference in the reception power of uplink signals of the wireless terminals constituting a pair is less than or equal to a predetermined value, a power difference measurement unit measuring the difference of reception power of uplink signals of the wireless terminals constituting a pair after instructing adjustment of the transmission power, a throughput calculation unit calculating the sum of throughput of uplink signals from all wireless terminals of the communication party when wireless terminals constituting a pair having the difference of reception power less than or equal to the predetermined value are set at the collaborative spatial multiplex mode, and a terminal setting unit identifying the pair that has the maximum sum of throughput calculated when set at the collaborative spatial multiplex mode, and setting the identified pair of wireless terminals at the collaborative spatial multiplex mode.

Preferably, the wireless base station includes a correlation coefficient calculation unit calculating a spatial correlation coefficient of known signals from the wireless terminals constituting a pair. The throughput calculation unit identifies the MCS (modulation and code scheme) when the uplink signals of the wireless terminals constituting a pair are spatial multiplexed based on the spatial correlation coefficient, and calculating, based on the identified MCS, the throughput of the uplink signals from the two wireless terminals constituting a pair.

Preferably, the wireless base station includes a candidate selection unit selecting a candidate terminal among the plurality of wireless terminals that becomes a candidate for being set at the collaborative spatial multiplex mode, a correlation coefficient calculation unit establishing a pair from the selected candidate terminals to calculate the spatial correlation coefficient of known signals from the wireless terminals constituting a pair, a throughput calculation unit calculating the sum of throughput of uplink signals from all wireless terminals of the communication party when two wireless terminals constituting a pair having a spatial correlation coefficient below a first threshold value are set at the collaborative spatial multiplex mode, and a terminal setting unit identifying a pair that has the maximum sum of throughput calculated when set at the collaborative spatial multiplex mode, and setting the identified wireless terminals constituting a pair at the collaborative spatial multiplex mode.

Preferably, the throughput calculation unit calculates throughput of uplink signals from the wireless terminals constituting a pair corresponding to a situation in which the MCS of uplink signals from wireless terminals constituting a pair having a spatial correlation coefficient that is greater than or equal to a second threshold value and below the first threshold value is reduced by a predetermined number of levels than the MCS when not set at the collaborative spatial multiplex mode, and calculates throughput of uplink signals from wireless terminals constituting a pair corresponding to a situation in which the MCS of uplink signals from wireless terminals constituting a pair having a spatial correlation coefficient below the second threshold value is made to confirm to the MCS when not set at the collaborative spatial multiplex mode.

Preferably, the wireless base station further includes an MCS setting unit setting the MCS of uplink signals from a wireless terminal set at the collaborative spatial multiplex mode to the MCS used in throughput calculation, and an MCS notification unit notifying the wireless terminal at the collaborative spatial multiplex mode of the set MCS.

Preferably, the wireless base station further includes a communication quality measurement unit measuring the communication quality of an uplink signal from a wireless terminal. The MCS setting unit sets the MCS of an uplink signal from the wireless terminal based on the communication quality of the uplink signal from the wireless terminal.

Preferably, the wireless base station further includes a communication quality measurement unit measuring the communication quality of an uplink signal from a wireless terminal, and an MCS setting unit setting the MCS of an uplink signal from a wireless terminal based on the communication quality of the uplink signal from the wireless terminal.

Preferably, the candidate selection unit identifies the MCS having the highest transmission data rate from the MCS of uplink signals of all wireless terminals of the communication party, and selects a candidate terminal from a plurality of wireless terminals having the identified MCS.

Preferably, the candidate selection unit selects a wireless terminal not currently set at the collaborative spatial multiplex mode among all wireless terminals of the communication party, as a candidate terminal.

Preferably, the throughput calculation unit calculates the sum of throughput of uplink signals from all wireless terminals of the communication party when the candidate terminal is not set at the collaborative spatial multiplex mode. For wireless terminals constituting a pair that has the maximum sum of throughput of uplink signals from all wireless terminals when set at the collaborative spatial multiplex mode, the terminal setting unit sets the wireless terminal at the collaborative spatial multiplex mode only in the case where the sum of throughput of uplink signals from all wireless terminals of the communication party is greater when set at the collaborative spatial multiplex mode than when not set at the collaborative spatial multiplex mode.

The present invention is directed to a wireless base station transmitting a downlink signal to a wireless terminal through a plurality of antennas. The wireless base station includes a plurality of antennas, a quality management unit acquiring or calculating communication quality of a downlink signal at a wireless terminal, a correlation calculation unit calculating a spatial correlation coefficient of known signals from the plurality of antennas of the wireless terminal, a switching unit switching the setting of the MIMO scheme of the downlink signals from a space-time coding type to a spatial multiplex type, or from the spatial multiplex type to the space-time coding type, and a transmission unit subjecting one data stream to space-time coding for output to the plurality of antennas when the set MIMO scheme is the space-time coding type, and subjecting a plurality of data streams to spatial multiplexing for output to the plurality of antennas when the set MIMO scheme is the spatial multiplex type. The switching unit switches the MIMO scheme of a downlink signal from the space-time coding type to the spatial multiplex type for a first type of wireless terminal transmitting a known signal from a plurality of antennas, when the communication quality and spatial correlation coefficient satisfy a predetermined condition.

Preferably, the wireless base station further includes a burst assignment unit determining an allocation of user data in a data burst region of a downlink frame transmitted from the wireless base station. When there is a wireless terminal having the MIMO scheme of a downlink signal modified to the spatial multiplex type by the switching unit, the burst assignment unit determines the allocation of user data in the data burst region based on the spatial correlation coefficient of a known signal transmitted from the plurality of antennas of the wireless terminal, for a wireless terminal whose MIMO scheme of a downlink signal is the spatial multiplex type among the first type of wireless terminals.

Preferably, the condition for switching the MIMO scheme of a downlink signal from the space-time coding type to the spatial multiplex type is determined individually for each wireless terminal.

Preferably, the wireless base station further includes a mode setting unit setting the mode of wireless communication from a normal mode to a trial mode at a predetermined timing, and a trial control unit modifying, in a trial mode, the condition for communication quality for switching the MIMO scheme of a downlink signal from the space-time coding type to the spatial multiplex type, and based on the modified condition for communication quality, switching the MIMO scheme of a downlink signal from the space-time coding type to the spatial multiplex type, and after switching to the spatial multiplex type, determining whether switching has succeeded or not based on whether the spatial multiplex type is maintained for a predetermined period. The trial control unit sets, based on the determination result, the condition for communication quality to be used in the normal mode.

Preferably, the mode setting unit sets the mode of wireless communication from a normal mode to a verification mode at a predetermined timing. The wireless base station includes a verification control unit switching, in a verification mode, the MIMO scheme of a downlink signal from the space-time coding type to the spatial multiplex type based on the condition for communication quality for switching the MIMO scheme of a downlink signal set at the normal mode from the space-time coding type to the spatial multiplex type, and after switching to the spatial multiplex type, determining whether switching has succeeded or not based on whether the spatial multiplex type is maintained for a predetermined period. The verification control unit causes the mode setting unit to shift to the trial mode based on the determination result.

The present invention is directed to a wireless base station transmitting a downlink signal to a wireless terminal through a plurality of antennas. The wireless base station includes a plurality of antennas, a quality management unit acquiring or calculating communication quality of a downlink signal at a wireless terminal, a switching unit switching the setting of the MIMO scheme of the downlink signal from a space-time coding type to a spatial multiplex type, or from the spatial multiplex type to the space-time coding type, and a transmission unit subjecting one data stream to space-time coding for output to the plurality of antennas when the set MIMO scheme is the space-time coding type, and subjecting a plurality of data streams to spatial multiplexing for output to the plurality of antennas when the set MIMO scheme is the spatial multiplex type. The switching unit switches, for a wireless terminal other than the first type of wireless terminal transmitting a known signal from the plurality of antennas, the MIMO scheme of a downlink signal from the space-time coding type to the spatial multiplex type when the condition for communication quality, higher than the condition for communication quality when the MCS (modulation and code scheme) is raised by one level under the same MIMO scheme, is satisfied.

Preferably, the wireless base station further includes a mode setting unit setting the mode of wireless communication from a normal mode to a trial mode at a predetermined timing, and a trial control unit modifying, in the trial mode, the condition for communication quality for switching the MIMO scheme of a downlink signal from the space-time coding type to the spatial multiplex type, and based on the modified condition for communication quality, switching the MIMO scheme of a downlink signal from the space-time coding type to the spatial multiplex type, and after switching to the spatial multiplex type, determining whether switching has succeeded or not based on whether the spatial multiplex type is maintained for a predetermined period. The trial control unit sets, based on the determination result, the condition for communication quality to be used in the normal mode.

Preferably, the mode setting unit sets the mode of wireless communication from the normal mode to a verification mode at a predetermined timing. The wireless base station includes a verification control unit switching, in a verification mode, the MIMO scheme of a downlink signal from the space-time coding type to the spatial multiplex type based on the condition for communication quality for switching the MIMO scheme of a downlink signal set at the normal mode from the space-time coding type to the spatial multiplex type, and, after switching to the spatial multiplex type, determining whether switching has succeeded or not based on whether the spatial multiplex type is maintained for a predetermined period. The verification control unit causes the mode setting unit to shift to the trial mode based on the determination result.

### Advantageous Effects of Invention

By appropriately setting a combination of wireless terminals for spatial multiplexing uplink signals to a wireless base station according to the present invention, high reception performance can be achieved at the wireless base station.

By appropriately switching the MIMO scheme of a downlink signal from the space-time coding type or the spatial coding scheme according to the present invention, high throughput property and area property as well as high frequency usage efficiency can be achieved at the wireless terminal.

### BRIEF DESCRIPTION OF DRAWINGS

FIG. 1 represents a configuration of a wireless communication system according to an embodiment of the present invention.

FIG. 2 represents a configuration of a wireless base station according to an embodiment of the present invention.

FIG. 3 represents an example of an MCS switching table.

FIG. 4 represents an example of a transmission data rate table.

FIG. 5 is a diagram to describe an example of throughput when uplink signals from all wireless terminals of the communication party are not collaborative spatial multiplexed.

FIG. 6 is a diagram to describe an example of throughput when an uplink signal from the wireless terminal of user A and an uplink signal from the wireless terminal of user B are collaborative spatial multiplexed.

FIG. 7 represents an example of a collaborative spatial multiplex pair table.

FIG. 8 represents a configuration of a wireless terminal according to an embodiment of the present invention.

FIG. 9 is a flowchart of an operation procedure of a wireless communication system according to an embodiment of the present invention.

FIG. 10 represents the details of step S114 in the flowchart of FIG. 9.

FIG. 11 represents a configuration of a wireless base station according to a second embodiment.

FIG. 12 represents an example of a communication quality level table.

FIG. 13 represents an example of a communication level switching rule for a first type wireless terminal,

FIG. 14 represents an example of a communication level switching rule for a second type wireless terminal.

FIG. 15 represents a configuration of a wireless terminal according to a second embodiment.

FIG. 16 is a flowchart of an operation procedure of a wireless communication system according to the second embodiment.

FIG. 17 is a flowchart representing detailed procedures of the operation at step S804 in the flowchart of FIG. 16.

FIG. 18 is a flowchart representing detailed procedures of the operation at step S805 in the flowchart of FIG. 16.

FIG. 19 represents a configuration of a wireless base station according to a third embodiment.

FIG. 20 represents an example of a switching history table for the first type of wireless terminal.

FIG. 21 represents an example of a switching history table for the second type of wireless terminal.

FIG. 22 represents an example of a switching success rate table for the first type of wireless terminal.

FIG. 23 represents an example of a switching success rate table for the second type of wireless terminal.

FIG. 24 represents an operation procedure of a trial mode at a wireless communication system according to a third embodiment.

FIG. 25 represents an operation procedure in a verification mode at the wireless communication system of the third embodiment.

FIG. 26 represents a configuration of a wireless base station according to a fourth embodiment.

FIG. 27 represents an example of a first assignment table.

FIG. 28 represents an example of a second assignment table.

FIG. 29 represents an example of a detection table.

FIG. 30 is a diagram to describe a process of determining an assignment position of user data in a downlink burst region.

FIG. 31 is a flowchart representing an operation procedure of assigning a burst region of a wireless base station according to a fourth embodiment,

FIG. 32 is a flowchart representing detailed procedures of the operation at step S608 in the flowchart of FIG. 31.

### DESCRIPTION OF EMBODIMENTS

Embodiments of the present invention will be described hereinafter with reference to the drawings.

### First Embodiment

(Configuration of Wireless Communication System]

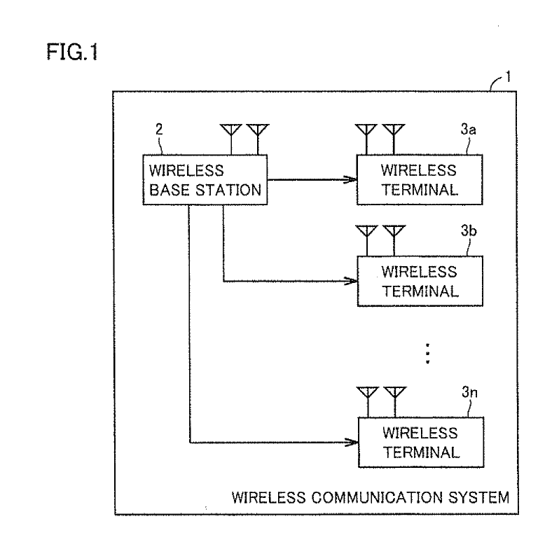

FIG. 1 represents a configuration of a wireless communication system according to an embodiment of the present invention,

Referring to FIG. 1, the wireless communication system includes a wireless base station 2, and n wireless terminals 3a-3n.

In the first embodiment, an uplink signal of user data is transmitted between wireless base station 2 and n wireless terminals 3a-3n of FIG. 1 in a communication scheme by collaborative spatial multiplexing or a communication scheme using a single antenna, Hereinafter, any one of wireless terminals 3a-3n will be represented as wireless terminal 3.

(Configuration of Wireless Base Station)

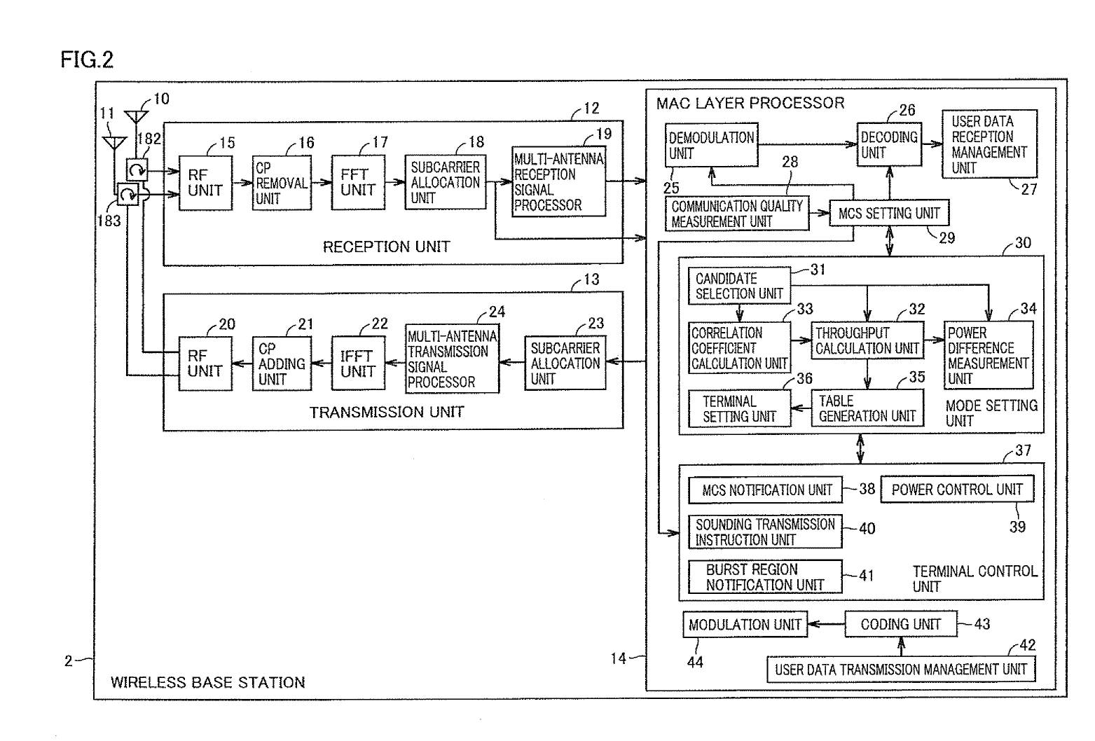

FIG. 2 represents a configuration of a wireless base station according to an embodiment of the present invention.

Referring to FIG. 2, wireless base station 2 includes a first antenna 10, a second antenna 11, a first couple/distributor 182, a second couple/distributor 183, a transmission unit 13, a reception unit 12, and an MAC (Media Access Control) layer processor 14.

First couple/distributor 182 is formed of a circulator, for example, and outputs a signal from transmission unit 13 to first antenna 10, and a signal from first antenna 10 to reception unit 12.

Second couple/distributor 183 is formed of a circulator, for example, to output a signal from transmission unit 13 to second antenna 11, and a signal from second antenna 11 to reception unit 12.

Transmission unit 13 includes a multi-antenna transmission signal processor 24, a subcarrier allocation unit 23, an IFFT (Inverse First Fourier Transform) unit 22, a CP (Cyclic Prefix) adding unit 21, and an RF (Radio Frequency) unit 20.

Subcarrier allocation unit 23 allocates a subcarrier based on, for example, PUSC (Partial Usage of Subchannels).

Multi-antenna transmission signal processor 24 subjects one data stream to space-time coding when the MIMO scheme of a downlink signal is set at the STC-based type, and subjects a plurality of data streams to spatial multiplexing when the MIMO scheme of a downlink signal is set at an SM-based type.

IFFT unit 22 converts a plurality of subcarrier signals (signals in the frequency range) output from multi-antenna transmission signal processor 24 into a signal of the time region (OFDMA (Orthogonal Frequency Division Multiple Access) symbol) by IFFT.

CP adding unit 21 adds a signal equivalent to the tail of the OFDMA symbol to the head of the OFDMA symbol as the CP.

RF unit 20 includes an up converter for up-converting a radio frequency band, a power amplification circuit amplifying an up-converted signal, and a bandpass filter for passing only the signal component of a desired band among the amplified signals for output to first antenna 10 and second antenna 11.

Reception unit 12 includes an RF unit 15, a CP removal unit 16, a FFT (First Fourier Transform) unit 17, a subcarrier allocation unit 18, and a multi-antenna reception signal processor 19.

RF unit 15 includes a bandpass filter passing through only the signal component of a desired band among signals output from first antenna 10 and second antenna 11, a low-noise amplification circuit amplifying an RF signal, a down converter for down-converting an RF signal, and the like.

CP removal unit 16 removes the CP from the signal output from RF unit 15.

FFT unit 17 converts the signal in the time region output from CP removal unit 16 into a signal in the frequency range by FFT for demodulation of a plurality of subcarriers.

Subcarrier allocation unit 18 extracts each subcarrier output from FFT unit 17 based on, for example, PUSC.

Multi-antenna reception signal processor 19 separates the spatial multiplexed uplink signal from wireless terminal 3 set at the collaborative spatial multiplex mode into an uplink signal from each wireless terminal 3.

MAC layer processor 14 includes a user data transmission management unit 42, a coding unit 43, a modulation unit 44, a demodulation unit 25, a decoding unit 26, a user data reception management unit 27, a communication quality measurement unit 28, an MCS (Modulation and Code Scheme) setting unit 29, a mode setting unit 30, and a terminal control unit 37.

User data transmission management unit 42 regulates user data to be transmitted to wireless terminal 3.

Coding unit 43 encodes a downlink signal towards wireless terminal 3.

Modulation unit 44 modulates the coded downlink signal.

Communication quality measurement unit 28 measures the packet error rate of an uplink signal from wireless terminal 3.

MCS setting unit 29 sets the MCS (modulation and code scheme) of an uplink signal for each wireless terminal 3 based on the packet error rate of an uplink signal from wireless terminal 3.

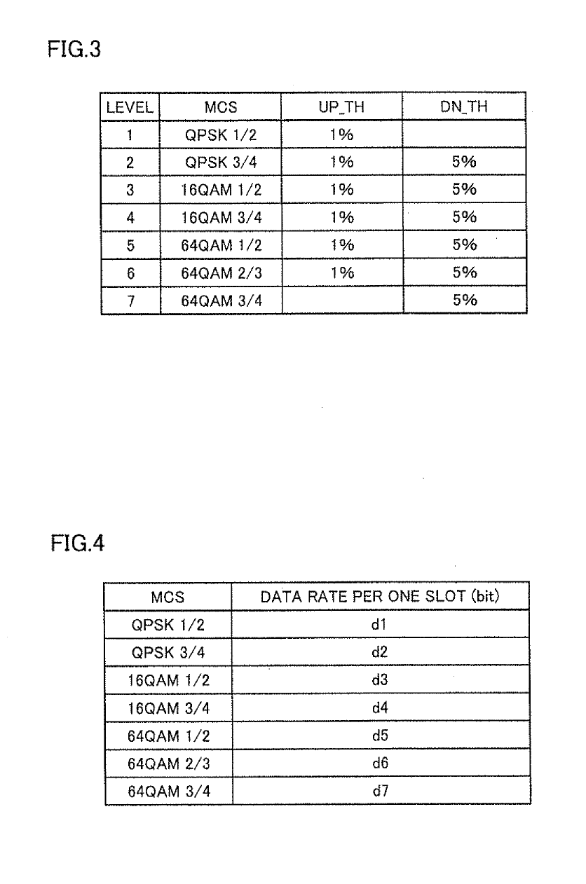

FIG. 3 represents an example of an MCS switching table.

Referring to FIG. 3, the MCS switching table determines the correspondence between the current MCS (modulation scheme and coding rate) and the packet error rate threshold values UP_TH and DN_TH of an uplink signal when the MCS is raised and lowered by one level, respectively.

For example, in the case where the current MCS corresponds to level 2 “QPSK ¾”, the MCS is modified to level 3 “16QAM ½” and to level 2 “QPSK ½” when the packet error rate of the uplink signal becomes less than or equal to 1 (%) and greater than or equal to 5 (%), respectively.

Demodulation unit 25 demodulates an uplink signal from wireless terminal 3 based on the MCS modulation scheme for each wireless terminal 3 set at MCS setting unit 29.

Decoding unit 26 decodes the demodulated uplink signal based on the MCS coding rate for each wireless terminal 3 set at MCS setting unit 29.

User data reception management unit 27 regulates the user data received from wireless terminal 3.

Mode setting unit 30 sets two wireless terminals 3 at the collaborative spatial multiplex mode (Collaborative Spatial Multiplexing) sharing the same uplink data burst region for usage based on throughput of uplink signals from all wireless terminals 3 of the communication party, Wireless base station 2 processes the uplink signals from the two wireless terminals 3 set at the collaborative spatial multiplex mode as signals from two antennas of one wireless terminal 3.

Mode setting unit 30 includes a candidate selection unit 31, a correlation coefficient calculation unit 33, a power difference measurement unit 34, a throughput calculation unit 32, a table generation unit 35, and a terminal setting unit 36.

Candidate selection unit 31 identifies the MCS of the highest transmission data rate of uplink signals of all wireless terminals 3 of the communication party, and selects a candidate terminal for the collaborative spatial multiplex mode from a plurality of wireless terminals 3 having the identified MCS of uplink signals.

Power difference measurement unit 34 measures the difference in the reception power of uplink signals from two wireless terminals 3 constituting a pair of candidate terminals.

Correlation coefficient calculation unit 33 calculates a reception response vector of a sounding signal transmitted with a plurality of subcarriers (for example, four consecutive subcarriers) in the sounding zone from wireless terminal 3 of one user A constituting the pair of candidate terminals, and a reception response vector of a sounding signal transmitted with a plurality of subcarriers in the sounding zone from wireless terminal 3 of the other user B constituting the pair of candidate terminals.

A reception signal X1(t) in the plurality of subcarriers in the sounding zone received at first antenna 10, and a reception signal X2(t) in the plurality of subcarriers in the sounding zone received at second antenna 11 are represented by equations (1) and (2) set forth below using a sounding signal S1 (t) in the plurality of subcarriers in the sounding zone transmitted from wireless terminal 3 of user A, a sounding signal S2 (t) in the plurality of subcarriers in the sounding zone transmitted from wireless terminal 3 of user B, a reception response vector H1(=[h11, h21]^{T} of a sounding signal in the plurality of subcarriers in the sounding zone from wireless terminal 3 of user A, and a reception response vector H2(=[h12, h22]^{T}) in the sounding signal in the plurality of subcarriers from wireless terminal 3 of user B.

X1(t)=h11×S1(t)+h12×S2(t)+N1(t) (1)

X2(t)=h21×S1(t)+h22×S2(t)+N2(t) (2)

where N1 (t) is the noise component included in reception signal X1 (t) received at first antenna 10, and N2 (t) is the noise component in reception signal X2 (t) received at second antenna 11.

Correlation coefficient calculation unit 33 calculates, according to equations (3) and (4) set forth below, reception response vector H1 of the sounding signal in the plurality of subcarriers in the sounding zone transmitted from wireless terminal 3 of user A, and reception response vector H2 of the sounding signal in the plurality of subcarriers in the sounding zone from wireless terminal 3 of user B.

H1=[h11,h21]^{T}=[E[X1(t)U1*(t)], E[X2(t)U1*(t)]]^{T} (3)

H2=[h12,h22]^{T}=[E[X1(t)U2*(t)], E[X2(t)U2*(t)]]^{T} (4)

where U1 (t) is a signal identical to S1 (t) held on part of wireless base station 2, U2 (t) is a signal identical to S2 (t) held on part of wireless base station 2, U1* (t) is the complex conjugate of U1 (t), U2* (t) is the complex conjugate of U2 (t), and E (X) represents the ensemble average (time average) of X.

Correlation coefficient calculation unit 33 calculates, according to equation (5) set forth below, a spatial correlation coefficient C of the sounding signal in the plurality of subcarriers in the sounding zone from wireless terminal 3 of user A, and the sounding signal in the plurality of subcarriers in the sounding zone from wireless terminal 3 of user B.

C=|(H1·H2)|/(H151 ×|H2|) (5)

where (X·Y) represents the inner product of vector X and vector Y, and |X| represents the magnitude of vector X.

Correlation coefficient calculation unit 33 calculates an average spatial correlation coefficient M_SR that is the average of the calculated spatial correlation coefficient C for every plurality of subcarriers over all the subcarriers included in the sounding zone. For example, when the total number of subcarriers is 1024, correlation coefficient calculation unit 33 obtains the spatial correlation coefficient C for every four continuous subcarriers, i.e. 256 spatial correlation coefficients C, and averages the 256 spatial correlation coefficients C to calculate average spatial correlation coefficient M_SR.

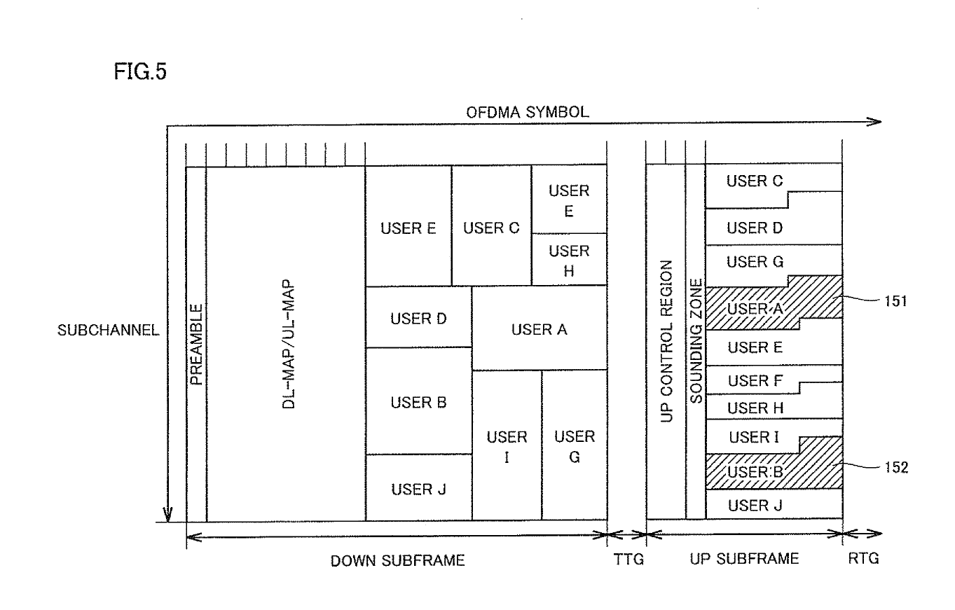

Throughput calculation unit 32 refers to the transmission data rate table shown in FIG. 4 to identify the data transmission rate per one slot corresponding to the MCS of the uplink signal of wireless terminal 3. Throughput calculation unit 32 multiplies the transmission data rate per slot by the number of slots of the data burst region assigned to the uplink signal of wireless terminal 3 to calculate the throughput of uplink signals from wireless terminal 3.

FIG. 4 represents an example of a transmission data rate table.

Referring to FIG. 4, the transmission data rate table defines the correspondence between the MCS and the data rate per one slot. For example, when the MCS is “QPSK ½”, the data rate per one slot is d1 (bit).

FIG. 5 is a diagram to describe an example of throughput when uplink signals from wireless terminals 3 of all the users in the communication party are not collaborative spatial multiplexed.

Referring to FIG. 5, when the uplink signal from wireless terminal 3 of user A and the uplink signal from wireless terminal 3 of user B are not collaborative spatial multiplexing, wireless terminal 3 of user A transmits the user data using a data burst region 151 whereas wireless terminal 3 of the user B transmits the user data using a data burst region 152. In a similar manner, the wireless terminal of other users transmits user data using a data burst region dedicated to itself.

In the case where the data rate per slot of the MCS at wireless terminal 3 of user A to user J is RA-RJ, and the number of slots of the data burst region is SA-SJ, the sum B_SP of the throughput of uplink signals from all wireless terminals of the communication party is calculated by the following equation.

B_{—}SP=RA×SA+RB×SB+RC×SC+RD×SD+RE×SE+RF×SF+RG×SG+RH×SH+RI×SI+RJ×SJ (6)

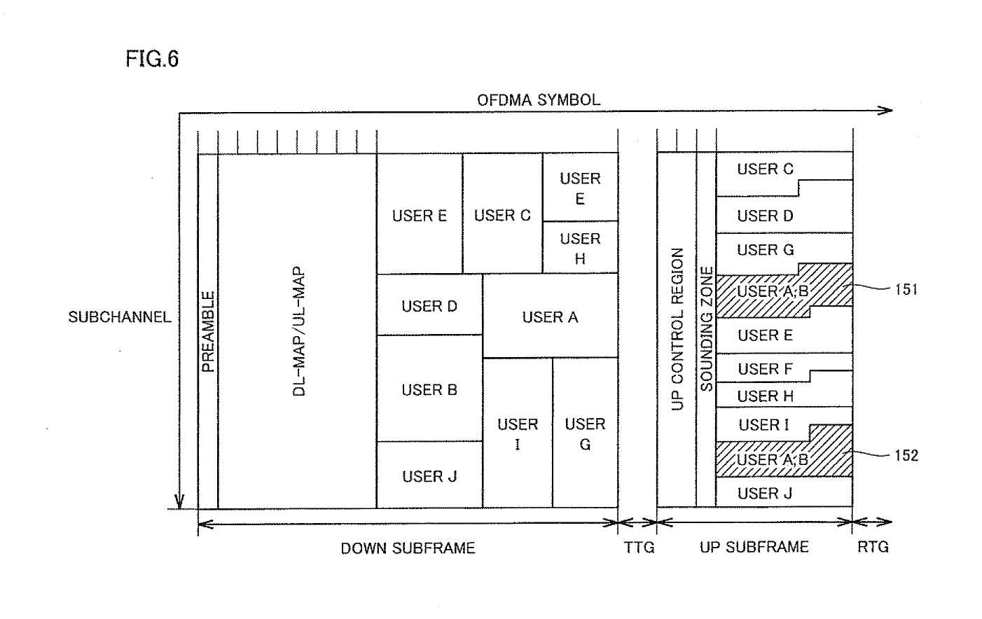

FIG. 6 is a diagram to describe an example of throughput when an uplink signal from wireless terminal 3 of user A and an uplink signal from wireless terminal 3 of user B are collaborative spatial multiplexed.

Referring to FIG. 6, when an uplink signal from wireless terminal 3 of user A and an uplink signal from wireless terminal 3 of user B are collaborative spatial multiplexed, wireless terminal 3 of user A transmits the user data using data burst region 151 and data burst region 152, and also wireless terminal 3 of user B transmits the user data using data burst region 151 and data burst region 152.

In the case where the data rate per slot of the MCS at wireless terminal 3 of user A when the uplink signal is collaborative spatial multiplexed is RAc, and the data rate per slot of the MCS at wireless terminal 3 of user B when the uplink signal is collaborative spatial multiplexed is RBc, the sum A_SP of throughput of uplink signals from all wireless terminals of the communication party is calculated by the following equation.

A_{—}SP=RAc×(SA+SB)+RBc×(SA+SB)+RC×SC+RD×SD+RE×SE+RF×SF+RG+SG+RH×SH+RI×SI+RJ×SJ (7)

Table generation unit 35 produces a collaborative spatial multiplex pair table defining a value A_SP that is the total of the throughput of uplink signals from all wireless terminals 3 of the communication party, when the uplink signal is collaborative spatial multiplexed, for those among the candidate pair of collaborative spatial multiplex that can have the difference in reception power of uplink signals from two wireless terminals 3 constituting a pair to be set to 0 dB (that is, power can be controlled), having an average spatial correlation coefficient of sounding signals from two wireless terminals 3 constituting a pair that is below a predetermined threshold value, and having an increased sum of throughput of uplink signals from all wireless terminals 3 of the communication party when the uplink signal is collaborative spatial multiplexed.

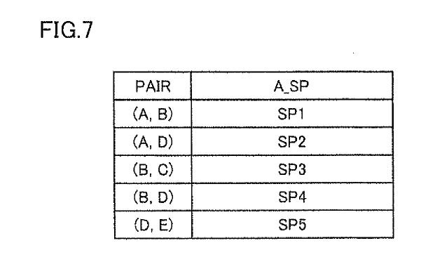

FIG. 7 represents an example of a collaborative spatial multiplex pair table.

Referring to FIG. 7, value A_SP that is the sum of throughput of uplink signals from all wireless terminals 3 of the communication party, when the uplink signals of a pair (A, B) are collaborative spatial multiplexed, is “SP1”.

Terminal setting unit 36 identifies the pair having the maximum throughput sum A_SP among the pairs in the collaborative spatial multiplex pair table, and sets the two wireless terminals 3 of the identified pair at the collaborative spatial multiplex mode.

Terminal control unit 37 includes an MCS notification unit 38, a burst region notification unit 41, a sounding transmission instruction unit 40, and a power control unit 39.

MCS notification unit 38 outputs a signal notifying wireless terminal 3 of the MCS of an uplink signal for each wireless terminal 3 set at MCS setting unit 29.

Sounding transmission instruction unit 40 outputs a signal notifying wireless terminals 3 of the generated pair to transmit a sounding signal.

Power control unit 39 outputs a signal notifying one or both of wireless terminals 3 constituting a pair to control the transmission power of uplink signals such that the difference in reception power of uplink signals from wireless terminals 3 constituting a pair attains a predetermined value (for example, 0 dB).

Burst region notification unit 41 outputs a signal notifying the assigned uplink data burst region in a downlink frame to each wireless terminal 3. It is to be noted that, for wireless terminals 3 constituting a pair set at the collaborative spatial multiplex mode, burst region notification unit 41 outputs in a downlink frame a signal notifying the uplink data burst region (a combined region of each of the regions) shared between wireless terminals 3 constituting a pair for usage.

(Configuration of Wireless Terminal)

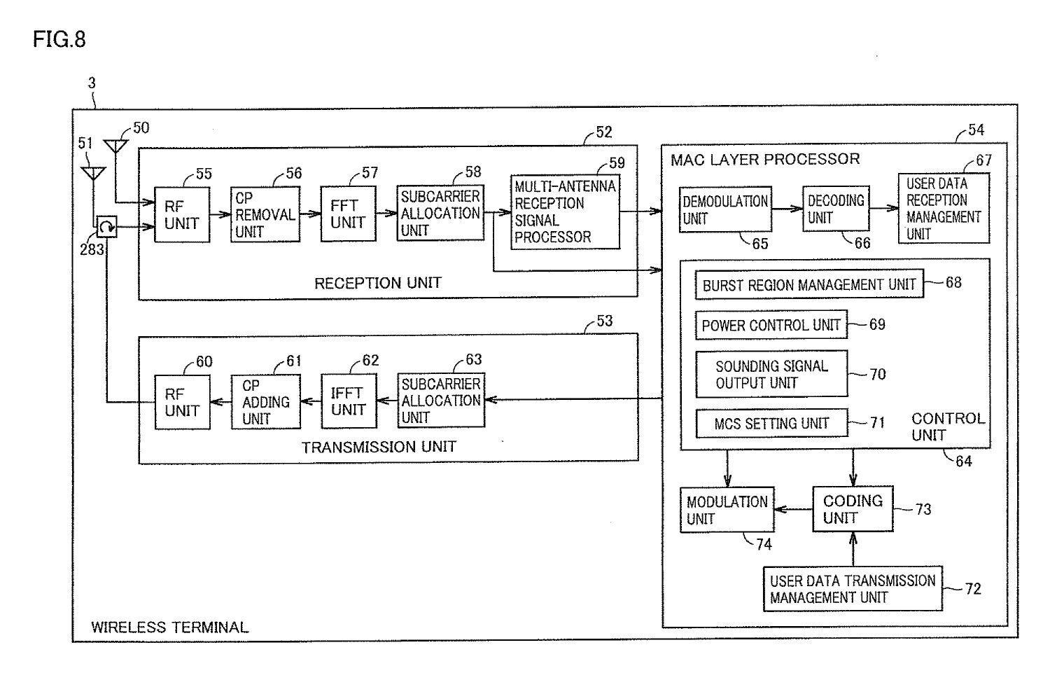

FIG. 8 represents a configuration of a wireless terminal according to an embodiment of the present invention.

Referring to FIG. 8, wireless terminal 3 includes a couple/distributor 283, a first antenna 50, a second antenna 51, a transmission unit 53, a reception unit 52, and a MAC layer processor 54.

Couple/distributor 283 is formed of a circulator, for example, to output a signal from transmission unit 53 to second antenna 51, and a signal from second antenna 51 to reception unit 52.

Transmission unit 53 includes a subcarrier allocation unit 63, an IFFT unit 62, a CP adding unit 61, and an RF unit 60.

Subcarrier allocation unit 63 allocates a subcarrier based on, for example, PUSC.

IFFT unit 62 converts a plurality of subcarrier signals (signal in frequency range) output from subcarrier allocation unit 63 into signals of a time region (OFDMA symbol) by IFFT.

CP adding unit 61 adds a signal equivalent to the tail of the OFDMA symbol to the head of the OFDMA symbol as a CP.

RF unit 60 includes an up converter for up-converting a radio frequency band, a power amplification circuit amplifying an up-converted signal, and a bandpass filter for passing only the signal component of a desired band among the amplified signals for output to second antenna 51.

Reception unit 52 includes an RF unit 55, a CP removal unit 56, an FFT unit 57, a subcarrier allocation unit 58, and a multi-antenna reception signal processing unit 59.

RF unit 55 includes a bandpass filter passing through only the signal component of a desired band among signals output from first antenna 50 and second antenna 51, a low-noise amplification circuit amplifying an RF signal, a down converter for down-converting an RF signal, and the like.

CP removal unit 56 removes the CP from the signal output from RF unit 55.

FFT unit 57 converts the signal in the time region output from CP removal unit 56 into a signal in the frequency range by FFT for demodulation of a plurality of subcarriers.

Subcarrier allocation unit 58 extracts each subcarrier output from FFT unit 57 based on, for example, PUSC.

Multi-antenna reception signal processor 59 subjects signals output from a plurality of antennas to space-time coding when the MIMO scheme of a downlink signal is set at the STC-based type to extract one data stream, and separates the signals output from a plurality of antennas to extract a plurality of data streams when the MIMO scheme of a downlink signal is set at the SM-based type.

MAC layer processor 54 includes a user data transmission management unit 72, a coding unit 73, a modulation unit 74, a demodulation unit 65, a decoding unit 66, a user data reception management unit 67, and a control unit 64.

User data transmission management unit 72 regulates user data to be transmitted to wireless base station 2.

Coding unit 73 encodes an uplink signal to wireless base station 2 according to the MCS coding rate set at MCS setting unit 71.

Modulation unit 74 modulates the coded uplink signal according to the MCS demodulation scheme set at MCS setting unit 71.

Demodulation unit 65 demodulates a downlink signal from wireless base station 2.

Decoding unit 66 decodes the demodulated downlink signal.

User data reception management unit 67 regulates the user data received from wireless base station 2.

Control unit 64 includes a burst region management unit 68, a power control unit 69, a sounding signal output unit 70, and an MCS setting unit 71.

Burst region management unit 68 receives notification of an uplink data burst region (when set at the collaborative spatial multiplex mode, the uplink data burst region shared by the wireless terminal of the other of the pair for usage) from wireless base station 2, and controls transmission unit 53 to assign the user data to the notified uplink data burst region.

Power control unit 69 controls, when receiving an instruction to adjust the transmission power of an uplink signal from a wireless base station 2, such that the transmission power of the uplink signal attains the designated value.

Sounding signal output unit 70 outputs the sounding signal according to an instruction from wireless base station 2.

MCS setting unit 71 controls the modulation scheme of modulation unit 74 and the coding rate of coding unit 73 according to the MCS notification from wireless base station 2.

(Operation)

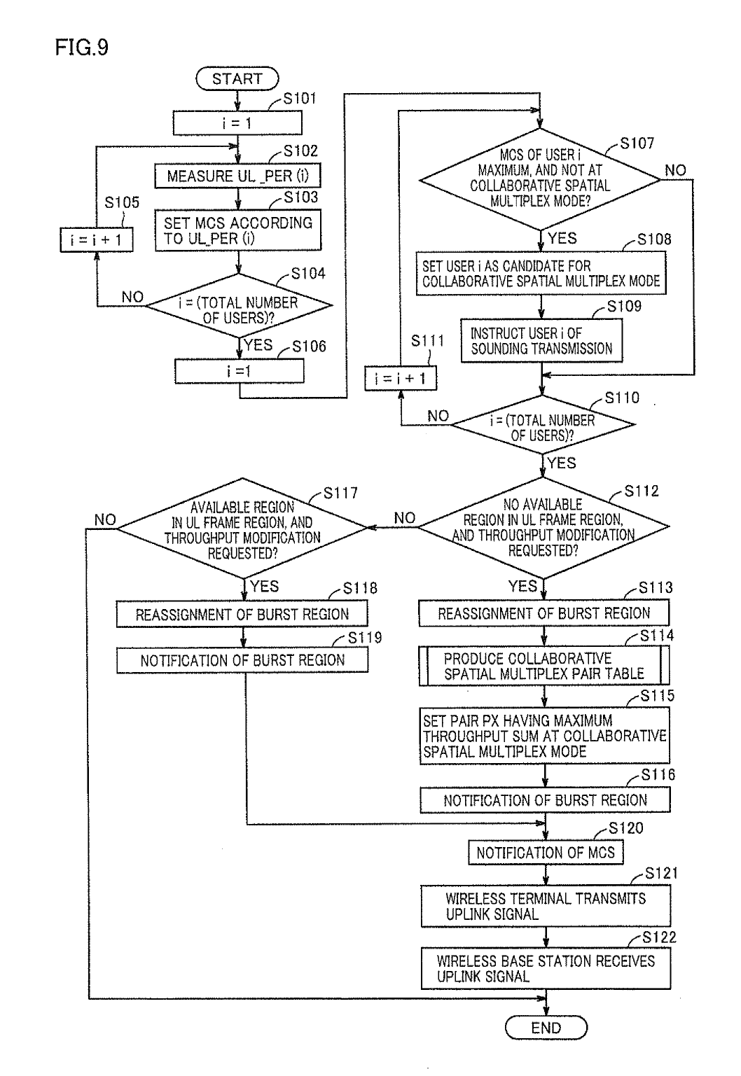

FIG. 9 is a flowchart of an operation procedure of the wireless communication system according to an embodiment of the present invention. The operation is carried out for every one OFDMA symbol, or for every predetermined number of OFDMA symbols.

Referring to FIG. 9, MCS setting unit 29 sets the user number i at 1 (step S101).

Communication quality measurement unit 28 measures the packet error rate UL_PER (i) of the data of wireless terminal 3 of user i (the user of user number i) of the uplink frame (step S102).

MCS setting unit 29 refers to the MCS switching table of FIG. 3 to set the MCS of the uplink signal based on packet error rate UL_PER (i) (step S103).

When the process of steps S102 and S103 has ended for all the users (YES at step S104), MCS setting unit 29 proceeds to step S106. In the case where process has not ended for all the users (NO at step S104), the user number i is incremented by 1 (step S105), and control returns to step S102.

Candidate selection unit 31 sets the user number i at 1 (step S106).

In the case where the MCS of wireless terminal 3 of user i corresponds to the highest transmission data rate among the MCS of the uplink signals for all wireless terminals 3 of the communication party, and wireless terminal 3 of user i is not set at the collaborative spatial multiplex mode (YES at step S107), candidate selection unit 31 sets user i as a candidate terminal for the collaborative spatial multiplex mode (step S108).

Sounding transmission instruction unit 40 transmits a signal indicating an instruction for wireless terminal 3 of user i to transmit sounding information in the downlink frame (step S109).

When the process of steps S108 and S109 has ended for all the users (YES at step S110), candidate selection unit 31 proceeds to step S111. When the process has not ended for all the users (NO at step S110), the user number i is incremented by 1 (step S111), and control returns to step S107.

When there is no available region in the uplink frame region, and the throughput request is modified (YES at step S112), terminal setting unit 36 uses proportional fairness or the like to reassign the uplink data burst region of each wireless terminal (step S113).

Then, table generation unit 35 produces a collaborative spatial multiplex pair table. The details will be described afterwards (step S114).

Terminal setting unit 36 refers to the collaborative spatial multiplex pair table to set the pair having the highest throughput sum (referred to as pair “PX”) at the collaborative spatial multiplex mode (step S115).

Burst region notification unit 41 outputs in a downlink frame a signal notifying each wireless terminal 3 of the uplink data burst region assigned at step S113. It is to be noted that, for wireless terminals 3 constituting a pair PX set at the collaborative spatial multiplex mode, burst region notification unit 41 outputs in a downlink frame a signal notifying the uplink data burst region (a combined region of each of the regions) shared between wireless terminals 3 constituting a pair PX for usage (step S116).

When there is an available region in the uplink frame region and throughput modification is requested (YES at S117), terminal setting unit 36 uses the empty region to reassign the uplink data burst region of each wireless terminal 3 based on proportional fairness or the like (step S118).

Burst region notification unit 41 outputs in a downlink frame a signal notifying each wireless terminal 3 of the uplink data burst region assigned at step S118 (step S119).

For a wireless terminal 3 having the MCS modified at step S103 as well as a wireless terminal 3 provisionally set to have the MCS lowered by one level in the case of collaborative spatial multiplexing at step S208 (described afterwards) MCS notification unit 38 output a signal notifying the MCS subsequent to modification in a downlink frame (step S120).

In the uplink frame subsequent to receiving notification of the MCS from wireless base station 2, coding unit 73 of wireless terminal 3 encodes the user data based on the notified MCS, and modulation unit 74 of wireless terminal 3 modulates the user data based on the notified MCS. In the uplink frame subsequent to receiving notification of the uplink data burst region shared between wireless terminals 3 of pair PX for usage from wireless base station 2, transmission unit 53 of wireless terminal 3 sends an uplink signal having the user data allocated in the notified uplink data burst region (step S121).

Multi-antenna reception signal processor 19 of wireless base station 2 separates the uplink signals spatial multiplexed at the shared uplink data burst region transmitted from two wireless terminals 3 of pair PX set at the collaborative spatial multiplex mode to extract signals from each wireless terminal 3. Demodulation unit 25 of wireless base station 2 demodulates the user data based on the set MCS. Decoding unit 26 of wireless base station 2 decodes the user data based on the set MCS (step S122).

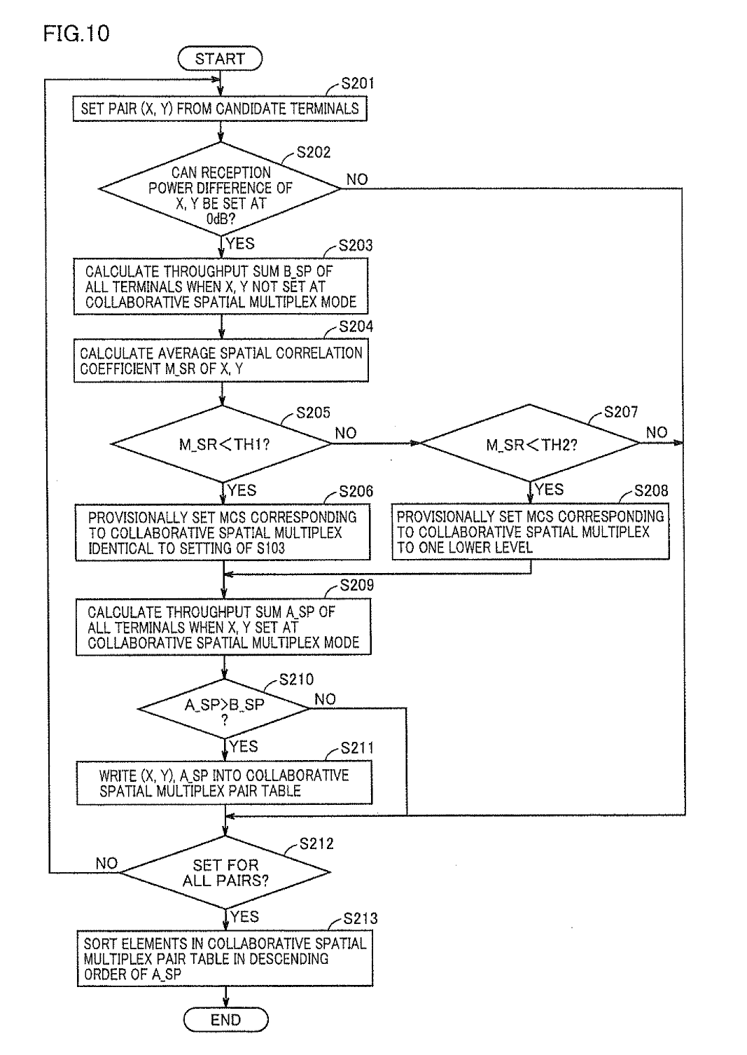

FIG. 10 represents the details of step S114 in the flowchart of FIG. 9.

Referring to FIG. 10, table generation unit 35 sets a pair (X, Y) from the candidate terminals for the collaborative spatial multiplex mode (step S201).

Power control unit 39 and power difference measurement unit 34 detects whether the difference between the reception power of an uplink signal from wireless terminal 3 of user X and the reception power of an uplink signal from wireless terminal 3 of user Y can be set at 0 dB or not. Specifically, power control unit 39 outputs a signal notifying adjustment of the transmission power of an uplink signal to one or both of wireless terminal 3 of user X and wireless terminal 3 of user Y such that the difference in reception power becomes 0 dB, based on the reception power of an uplink signal from wireless terminal 3 of user X and wireless terminal 3 of user Y measured up to date. Power control unit 69 of wireless terminal 3 controls the transmission power of the uplink signal to attain the designated value upon receiving an instruction to adjust the transmission power of the uplink signal from wireless base station 2. Power difference measurement unit 34 measures the difference between the reception power of an uplink signal from wireless terminal 3 of user X and the reception power of an uplink signal from wireless terminal 3 of user Y.

When the difference of reception power can be set at 0 dB, i.e. when the power can be controlled (YES at step S202), throughput calculation unit 32 calculates the sum B_SP of throughput of uplink signals from all wireless terminals 3 of the communication party corresponding to the case where the uplink signals of user X and user Y are not collaborative spatial multiplexed (step S203), based on the size of the burst region of each user assigned at step S113 and the MCS of each user set at step S103.

Then, correlation coefficient calculation unit 33 calculates the average spatial correlation coefficient M_SR of the uplink signal from wireless terminal 3 of user X and the uplink signal from wireless terminal 3 of user Y (step S204).

When average spatial correlation coefficient M_SR is below a threshold value TH1 (YES at step S205), MCS setting unit 29 provisionally sets the MCS of wireless terminal 3 of user X when an uplink signal is to be collaborative spatial multiplexed equal to the MCS of wireless terminal 3 of user X set at step S103, and provisionally sets the MCS of wireless terminal 3 of user Y when an uplink signal is to be collaborative spatial multiplexed equal to the MCS of wireless terminal 3 of user Y set at step S103 (step S206).

When average spatial correlation coefficient M_SR is greater than or equal to threshold TH1 and below a threshold TH2 (NO at step S205 and YES at step S207), MCS setting unit 29 provisionally sets the MCS of wireless terminal 3 of user X when an uplink signal is to be collaborative spatial multiplexed at an MCS that is lowered by just one level than the MCS of wireless terminal 3 of user X set at step S103, and provisionally sets the MCS of wireless terminal 3 of user Y when an uplink signal is to be collaborative spatial multiplexed at an MCS that is lowered by just one level than the MCS of wireless terminal 3 of user Y set at step S103 (step S208).

Then, throughput calculation unit 32 calculates the sum A_SP of throughput of uplink signals from all wireless terminals 3 of the communication party corresponding to the case where the uplink signals of user X and user Y are collaborative spatial multiplexed, based on the MCS provisionally set at step S206 or S208 for users X and Y, the MCS set at step S103 for other users of the communication party, and the size of the burst region of each user assigned at step S113 (the size of the combined region of each of the burst regions of X and Y) (step S209).

When throughput sum A_SP corresponding to the case subjected to collaborative spatial multiplex is greater than the throughput sum B_SP corresponding to the case not subjected to collaborative spatial multiplex (YES at step S210), the pair (X, Y) and the throughput sum A_SP are written into the collaborative spatial multiplex table (step S211).

When the process of steps S201-S211 has been ended for all the possible pairs (YES at step S212), table generation unit 35 proceeds to step S213. In the case where the process has not ended for all the possible pairs (NO at step S212), control returns to step S201 to repeat this process for pairs not yet subjected to the process.

Then, table generation unit 35 sorts the elements in the collaborative spatial multiplex table in the descending order of throughput sum A_SP (step S213).

### SUMMARY

According to the wireless communication system of the embodiment of the present invention, high reception performance can be achieved at a wireless terminal by setting the combination of wireless terminals for spatial multiplexing an uplink signal to the wireless base station based on the throughput.

### Second Embodiment

In the second to fourth embodiments, a downlink signal of user data is transmitted between wireless base station 2 and n wireless terminals 3a-3n of FIG. 1 according to the MIMO scheme of the space-time coding type (DL MIMO MATRIX-A) or the MIMO scheme of the spatial multiplex type (DL MIMO MATRIX-B).

(Configuration of Wireless Base Station)

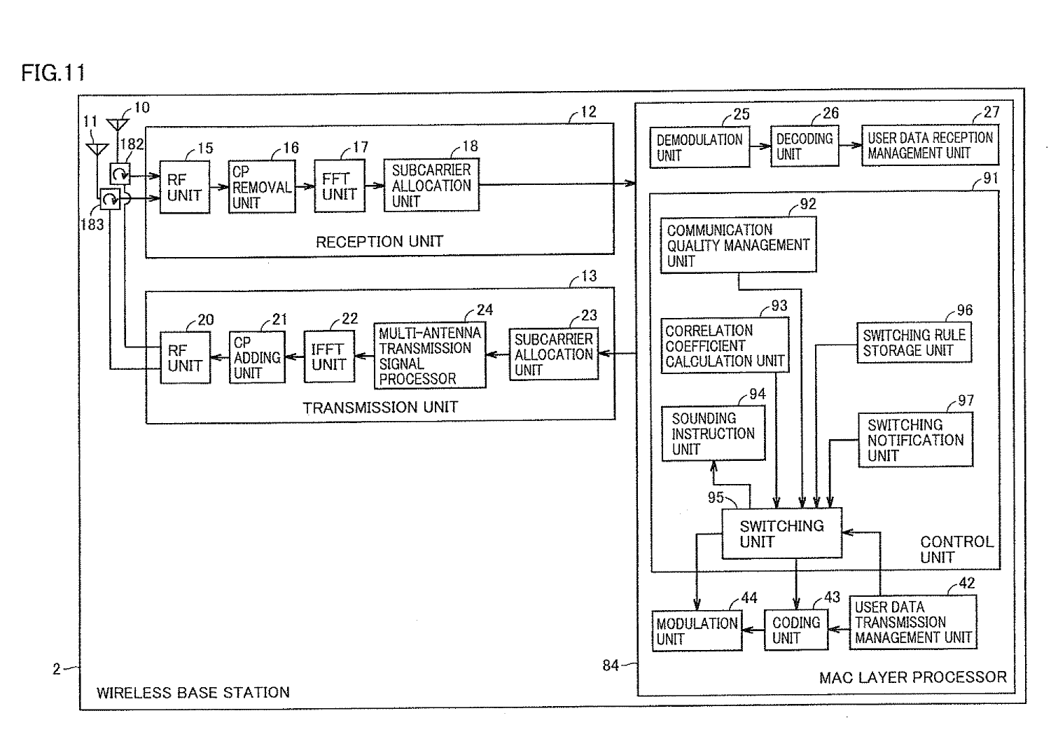

FIG. 11 represents a configuration of a wireless base station according to the second embodiment.

Referring to FIG. 11, wireless base station 2 includes a first couple/distributor 182, a second couple/distributor 183, a first antenna 10, a second antenna 11, a transmission unit 13, a reception unit 12, and an MAC (Media Access Control) layer processor 84.

First couple/distributor 182 is formed of a circulator, for example, and outputs a signal from transmission unit 13 to first antenna 10, and a signal from first antenna 10 to reception unit 12.

Second couple/distributor 183 is formed of a circulator, for example, to output a signal from transmission unit 13 to second antenna 11, and a signal from second antenna 11 to reception unit 12.

Transmission unit 13 includes a multi-antenna transmission signal processor 24, a subcarrier allocation unit 23, an IFFT (Inverse First Fourier Transform) unit 22, a CP (Cyclic Prefix) adding unit 21, and an RF (Radio Frequency) unit 20.

Subcarrier allocation unit 23 allocates a subcarrier based on, for example, PUSC (Partial Usage of Subchannels).

Multi-antenna transmission signal processor 24 subjects one data stream to space-time coding (for example, Alamouti coding) when the set MIMO scheme is MATRIX-A, and subjects a plurality of data streams to spatial multiplexing when the set MIMO scheme is MATRIX-B.

IFFT unit 22 converts a plurality of subcarrier signals (signals in the frequency range) output from multi-antenna transmission signal processor 24 into a signal of the time region (OFDMA (Orthogonal Frequency Division Multiple Access) symbol) by IFFT.

CP adding unit 21 adds a signal equivalent to the tail of the OFDMA symbol to the head of the OFDMA symbol as the CP.

RF unit 20 includes an up converter for up-converting a radio frequency band, a power amplification circuit amplifying an up-converted signal, and a bandpass filter for passing only the signal component of a desired band among the amplified signals for output to first antenna 10 and second antenna 11.

Reception unit 12 includes an RF unit 15, a CP removal unit 16, an FFT unit 17, and a subcarrier allocation unit 18.

RF unit 15 includes a bandpass filter passing through only the signal component of a desired band among signals output from first antenna 10 and second antenna 11, a low-noise amplification circuit amplifying an RF signal, a down converter for down-converting an RF signal, and the like.

CP removal unit 16 removes the CP from the signal output from RF unit 15.

FFT unit 17 converts the signal in a time region output from CP removal unit 16 into a signal in a frequency range by FFT for demodulation of a plurality of subcarriers.

Subcarrier allocation unit 18 extracts each subcarrier output from FFT unit 17 based on, for example, PUSC.

MAC layer processor 84 includes a user data transmission management unit 42, a coding unit 43, a modulation unit 44, a demodulation unit 25, a decoding unit 26, a user data reception management unit 27, and a control unit 91.

User data transmission management unit 42 regulates user data to be transmitted to wireless terminal 3.

Coding unit 43 encodes a coded downlink signal according to the MCS coding rate designated by switching unit 95.

Modulation unit 44 modulates the downlink signal towards wireless terminal 3 according to the MCS modulation scheme designated by switching unit 95.

Demodulation unit 25 demodulates the uplink signal from wireless terminal 3.

Decoding unit 26 decodes the demodulated uplink signal.

User data reception management unit 27 regulates the user data received from wireless terminal 3.

Control unit 91 includes a communication quality management unit 92, a correlation coefficient calculation unit 93, a sounding instruction unit 94, a switching unit 95, a switching rule storage unit 96, and a switching notification unit 97.

Communication quality management unit 92 receives from each wireless terminal 3 notification of a packet error rate of a downlink signal measured at each wireless terminal 3, and stores the notified packet error rate.

Sounding instruction unit 94 outputs a signal instructing a first type of wireless terminal 3 to transmit a sounding signal in a downlink frame. As used herein, a first type of wireless terminal refers to a wireless terminal that can transmit sounding signals from two antennas simultaneously to each other or at different times. A second type of wireless terminal refers to a wireless terminal other than the first type of wireless terminal. Namely, the second type of wireless terminal includes a wireless terminal that transmits a sounding signal from only one predetermined antenna, and a wireless terminal that does not transmit a sounding signal. The first type of wireless terminal transmits a sounding signal to wireless base station 2 in response to a transmission instruction of the sounding signal. A sounding signal is a signal included in the sounding zone in an uplink frame of the OFDMA symbol, as shown in FIG. 3.

Correlation coefficient calculation unit 93 calculates a reception response vector of a sounding signal transmitted with a plurality of subcarriers (for example, four consecutive subcarriers) in the sounding zone from first antenna 50 of each wireless terminal 3, and a reception response vector of a sounding signal transmitted with a plurality of subcarriers in the sounding zone from second antenna 51 of each wireless terminal 3.

A reception signal X1 (t) in a plurality of subcarriers in the sounding zone received at first antenna 10 of wireless base station 2, and a reception signal X2 (t) in a plurality of subcarriers in the sounding zone received at second antenna 11 of wireless base station 2 are represented by equations (8) and (9) set forth below using a sounding signal S1 (t) in the plurality of subcarriers in the sounding zone transmitted from first antenna 50 of wireless terminal 3, a sounding signal S2 (t) in the plurality of subcarriers in the sounding zone transmitted from second antenna 51 of wireless terminal 3, a reception response vector H1(=[h11, h21]^{T}) of a sounding signal in the plurality of subcarriers in the sounding zone from first antenna 50 of wireless terminal 3, and a reception response vector H2(=[h12, h22]^{T}) in the sounding signal in the plurality of subcarriers from second antenna 51 of wireless terminal 3 of user B.

X1(t)=h11×S1(t)+h1233 S2(t)+N1(t) (8)

X2(t)=h21×S1(t)+h22×S2(t)+N2(t) (9)

where N1 (t) is the noise component included in reception signal X1 (t) received at first antenna 10 of wireless base station 2, and N2 (t) is the noise component in reception signal X2 (t) received at second antenna 11 of wireless base station 2.

Correlation coefficient calculation unit 93 calculates, according to equations (10) and (11) set forth below, reception response vector H1 of the sounding signal in the plurality of subcarriers in the sounding zone from first antenna 50 of wireless terminal 3, and reception response vector H2 of the sounding signal in the plurality of subcarriers in the sounding zone from second antenna 51 of wireless terminal 3.

H1=[h11,h21]^{T}=[E[X1(t)U1*(t)], E[X2(t)U1*(t)]]^{T} (10)

H2=[h12,h22]^{T}=[E[X1(t)U2*(t)], E[X2(t)U2*(t)]]^{T} (11)

where U1 (t) is a signal identical to S1 (t) held on part of wireless base station 2, U2 (t) is a signal identical to S2 (t) held on part of wireless base station 2, U1* (t) is the complex conjugate of U1 (t), U2* (t) is the complex conjugate of U2 (t), and E (X) represents the ensemble average (time average) of X.

Correlation coefficient calculation unit 93 calculates, according to equation (12) set forth below, a spatial correlation coefficient C of the sounding signal in the plurality of subcarriers in the sounding zone from first antenna 50 of wireless terminal 3, and the sounding signal in the plurality of subcarriers in the sounding zone from second antenna 51 of wireless terminal 3.

C=|(H1·H2)|/(H1|×|H2) (12)

where (X·Y) represents the inner product of vector X and vector Y, and |X| represents the level of vector X.

Correlation coefficient calculation unit 93 calculates an average spatial correlation coefficient SP that is the average of the calculated spatial correlation coefficient C for every plurality of subcarriers over all the subcarriers included in the sounding zone. For example, when the total number of subcarriers is 1024, correlation coefficient calculation unit 93 obtains the spatial correlation coefficient C for every four continuous subcarriers, i.e. 256 spatial correlation coefficients C, and averages the 256 spatial correlation coefficients C to calculate average spatial correlation coefficient SP.

Switching rule storage unit 96 stores the communication level switching rule.

Switching unit 95 switches the MIMO scheme and MCS (modulation and code scheme) of a downlink signal for each wireless terminal 3, according to the communication level switching rule in switching rule storage unit 96.

(Communication Level Table)

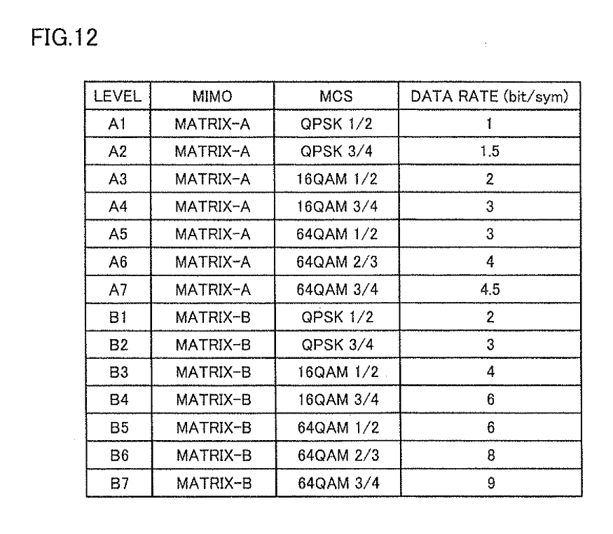

FIG. 12 represents an example of a communication level table.

Referring to FIG. 12, the communication level table represents the relationship among the communication level, the MIMO scheme and MCS, and the data rate.

For example, communication level “A1” represents the MIMO scheme at “MATRIX-A”, the MCS at “QPSK ½”, and the data rate at “1” (bit/symbol).

In the case where the level is to be modified from any of “A1-A7” to “B1-B7”, i.e. when the MIMO scheme is to be modified from MATRIX-A to MATRIX-B, the present specification cites the “MATRIX is raised in level”. When the level is modified from any of “B1-B7” to any of “A1-A7”, i.e. when the MIMO scheme is modified from MATRIX-B to MATRIX-A, the present specification cites the “MATRIX is lowered in level”.

In the case of modification of the MCS to a high data rate and to a low data rate under the same MIMO scheme, the present specification cites “MCS is raised in level” and “MCS is lowered in level”, respectively.

(Communication Level Switching Rule)

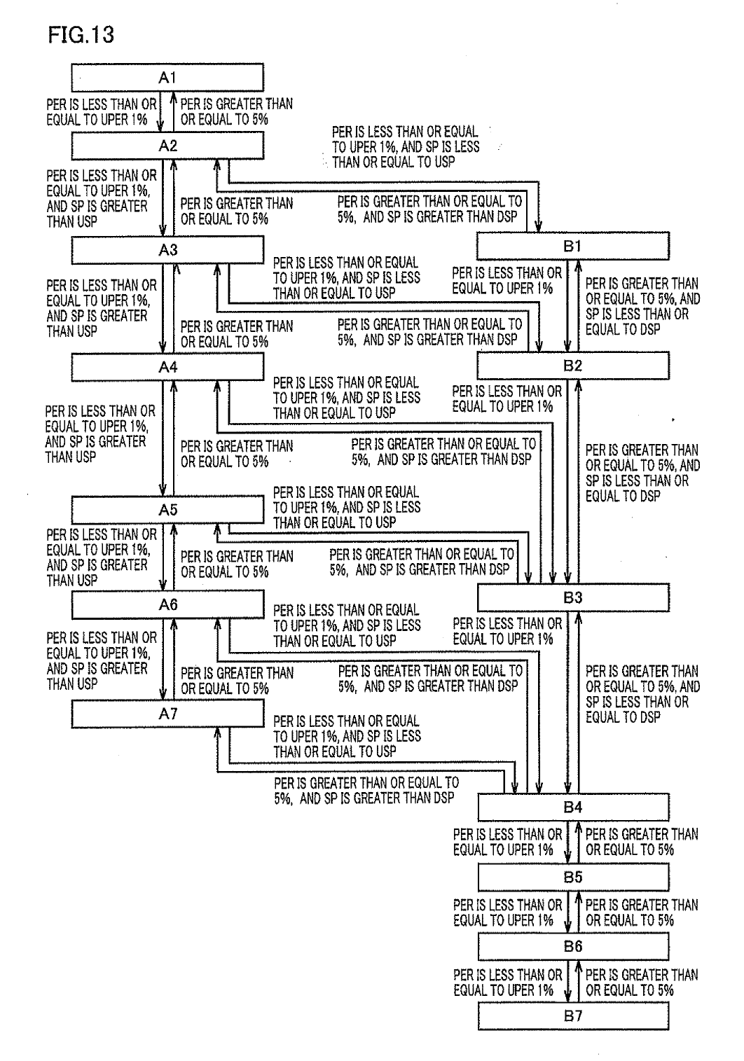

FIG. 13 represents an example of a communication level switching rule at a first type of wireless terminal.

Referring to FIG. 13, according to the communication level switching rule at the first type of wireless terminal, the communication level is switched based on a packet error rate PER of downlink signals and average spatial correlation coefficient SP of sounding signals from two antennas. The reason why average spatial correlation coefficient SP is used as a condition for switching the communication level is that, since a sounding signal can be transmitted from two antennas at the first type of wireless terminal, a determination can be made whether a signal subjected to spatial multiplex at the wireless terminal side can be separated appropriately or not, when downlink signals from wireless base station 2 are spatial multiplexed, depending upon the spatial correlation coefficient of the sounding signal.

Referring to FIG. 13, in the case where the current communication level is “A2”, for example, and when packet error rate PER of the downlink signal is greater than or equal to “5(%)”, the communication level is lowered in level to “A1”. In the case where the current communication level is “A2”, and when packet error rate PER of the downlink signal is less than or equal to “UPER 1(%)”, and the average spatial correlation coefficient SP is greater than “USP”, the level is raised to “A3” maintaining MATRIX-A. When packet error rate PER of the downlink signal is less than or equal to “UPER 1(%)” and the average spatial correlation coefficient SP is less than or equal to “USP”, the level is raised to “B1” in which the MATRIX is modified. For example, in the case where the current communication level is “B2”, and when packet error rate PER of the downlink signal is less than or equal to “UPER 1(%)”, the communication level is raised to “B3”. In the case where the current communication level is “B2”, and when packet error rate PER of the downlink signal is greater than or equal to “5(%)” and average spatial correlation coefficient SP is less than or equal to “DSP”, the level is lowered to “B1” maintaining MATRIX-B. When the packet error rate PER of the downlink signal is greater than or equal to “5(%)”, and average spatial correlation coefficient SP is greater than “DSP”, the communication level is raised to “A3” in which the MATRIX is modified. As used herein, “UPER 1(%)” can be set to “1(%)”, for example.

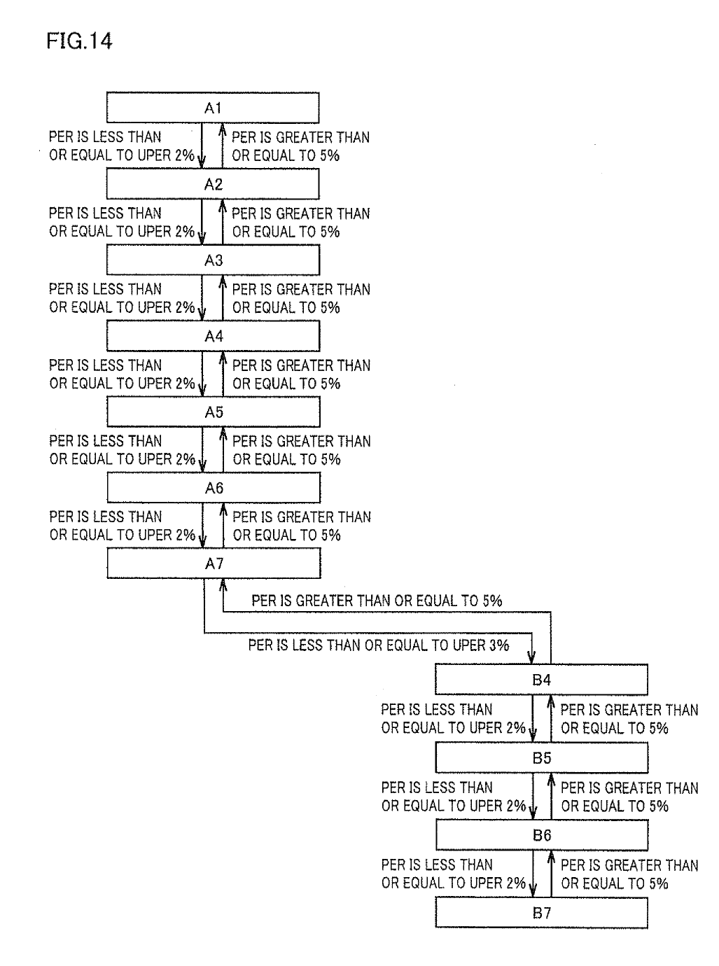

FIG. 14 represents an example of a communication level switching rule at a second type of wireless terminal. In FIG. 14, UPER 2>UPER 3.

According to the communication level switching rule at the second type of wireless terminal in FIG. 14, the packet error rate threshold value UPER 3 when the MATRIX is to be raised is set lower than packet error rate threshold value UPER 2used in raising the MCS under the same MATRIX (that is, set to the better communication quality). The reason why threshold value UPER 3 is set lower than threshold value UPER 2 is that, since it cannot be predicted how the throughput property and area property, as well as frequency usage efficiency change on part of wireless terminal 3 when the MATRIX is raised in level, a strict condition is imposed in the communication quality when the MATRIX is to be raised.

In FIG. 14, for example, when packet error rate PER of the downlink signal is greater than or equal to “5(%)”, the communication level is lowered by one level. In the case where packet error rate PER of the downlink signal is less than or equal to “UPER 2(%)” when the current communication level is “A6”, the communication level is raised in level to “A7” maintaining MATRIX-A. In the case where packet error rate PER of the downlink signal is less than or equal to “UPER 3(%)” when the current communication level is “A7”, the communication level is raised to “B4” in which the MATRIX is modified, Under the circumstance of UPER 2>UPER 3, the communication quality condition for modifying the MATRIX is strictly set, For “UPER 2(%)”, “1%”, for example, can be set. For “UPER 3(%)”, “0.5(%)”, for example, can be set.

Switching notification unit 97 outputs a signal notifying a wireless terminal of the MIMO scheme and MCS of a downlink signal subsequent to switching by switching unit 95.

(Configuration of Wireless Terminal)

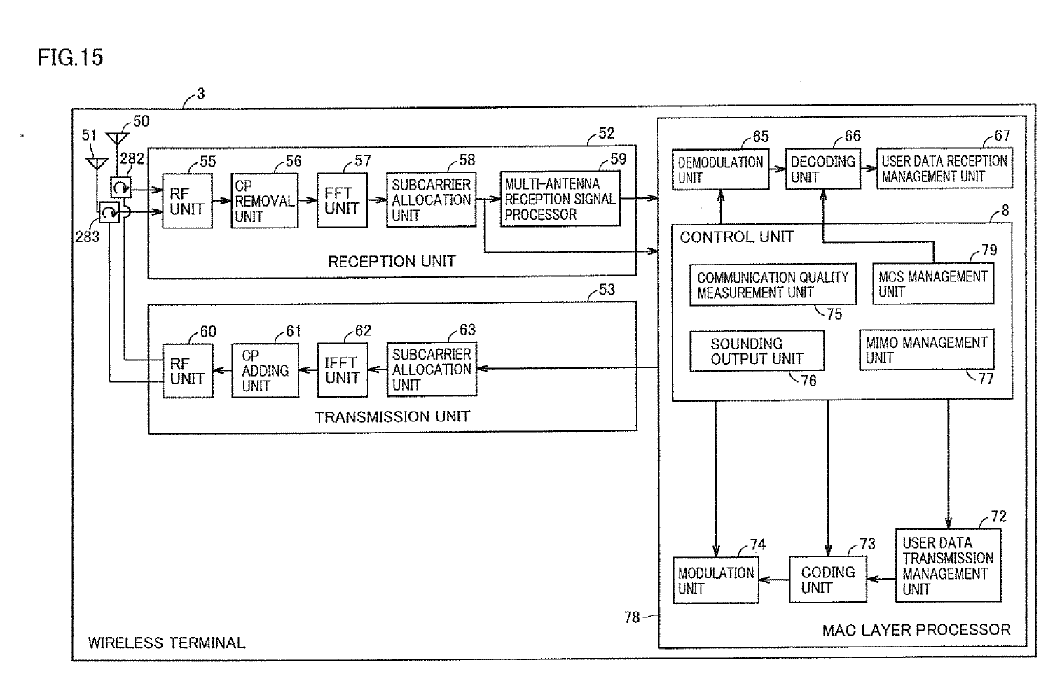

FIG. 15 represents a configuration of a wireless terminal according to a second embodiment.

Referring to FIG. 15, wireless terminal 3 includes a first antenna 50, a second antenna 51, a transmission unit 53, a reception unit 52, and a MAC layer processor 78.

First couple/distributor 282 is formed of a circulator, for example, to output a signal from transmission unit 53 to first antenna 50, and a signal from first antenna 50 to reception unit 52.

Second couple/distributor 283 is formed of a circulator, for example, to output a signal from transmission unit 53 to second antenna 51, and a signal from second antenna 51 to reception unit 52.

Transmission unit 53 includes a subcarrier allocation unit 63, an IFFT unit 62, a CP adding unit 61, and an RF unit 60.

Subcarrier allocation unit 63 allocates a subcarrier based on, for example, PUSC. IFFT unit 62 converts a plurality of subcarrier signals (signal in frequency range) output from subcarrier allocation unit 63 into signals of a time region (OFDMA symbol) by IFFT.

CP adding unit 61 adds a signal equivalent to the tail of the OFDMA symbol to the head of the OFDMA symbol as a CP.

RF unit 60 includes an up converter for up-convening a radio frequency band, a power amplification circuit amplifying an up-converted signal, and a bandpass filter for passing only the signal component of a desired band among the amplified signals for output to first and second antennas 50 and 51.

Reception unit 52 includes an RF unit 55, a CP removal unit 56, an FFT unit 57, a subcarrier allocation unit 58, and a multi-antenna reception signal processor 59.

RF unit 55 includes a bandpass filter passing through only the signal component of a desired band among signals output from first antenna 50 and second antenna 51, a low-noise amplification circuit amplifying an RF signal, a down converter for down-converting an RF signal, and the like.

CP removal unit 56 removes the CP from the signal output from RF unit 55.

FFT unit 57 converts the signal in the time region output from CP removal unit 56 into a signal in a frequency range by FFT for demodulation of a plurality of subcarriers.

Subcarrier allocation unit 58 extracts each subcarrier output from FFT unit 57 based on, for example, PUSC.

Multi-antenna reception signal processor 59 subjects signals output from two antennas 50 and 51 to space-time coding when the MIMO scheme of a downlink signal notified from wireless base station 2 is set at MATRIX-A to extract one data stream, and separates the signals output from two antennas 50 and 51 when the MIMO scheme of a downlink signal notified from wireless base station 2 is set at MATRIX-B to extract a plurality of data streams.

MAC layer processor 78 includes a user data transmission management unit 72, a coding unit 73, a modulation unit 74, a demodulation unit 65, a decoding unit 66, a user data reception management unit 67, and a control unit 8.

User data transmission management unit 72 regulates user data to be transmitted to wireless base station 2.

Coding unit 73 encodes an uplink signal towards wireless base station 2.

Modulation unit 74 modulates the coded uplink signal.

Demodulation unit 65 demodulates a downlink signal from wireless base station 2 according to the MCS demodulation scheme set at MCS management unit 79,

Decoding unit 66 decodes the demodulated downlink signal according to the MCS coding rate set at MCS management unit 79.

User data reception management unit 67 regulates the user data received from wireless base station 2.

Control unit 8 includes a communication quality measurement unit 75, an MCS management unit 79, an MIMO management unit 77, and a sounding signal output unit 76.

Communication quality measurement unit 75 measures the packet error rate of the received downlink signal for transmission to wireless base station 2.

MCS management unit 79 controls demodulation unit 65 and decoding unit 66 based on the notified MCS from wireless base station 2.

MIMO management unit 77 controls multi-antenna reception signal processor 59 based on the notified MIMO scheme from wireless base station 2.

Sounding output unit 76 receives a sounding instruction from wireless base station 2 to generate a sounding signal included in the sounding zone of the uplink frame. In the case where wireless terminal 3 of FIG. 15 is the first type wireless terminal, the generated sounding signal is output from first antenna 50 and second antenna 51. In the case where wireless terminal 3 of FIG. 15 is a wireless terminal transmitting a sounding signal from only one predetermined antenna among the second type of wireless terminals, the generated sounding signal is output from only the predetermined one of first and second antennas 50 and 51. In the case where wireless terminal 3 of FIG. 15 is a wireless terminal that does not transmit a sounding signal among the second type of wireless terminals, this sounding output unit 76 is absent.

(Operation)

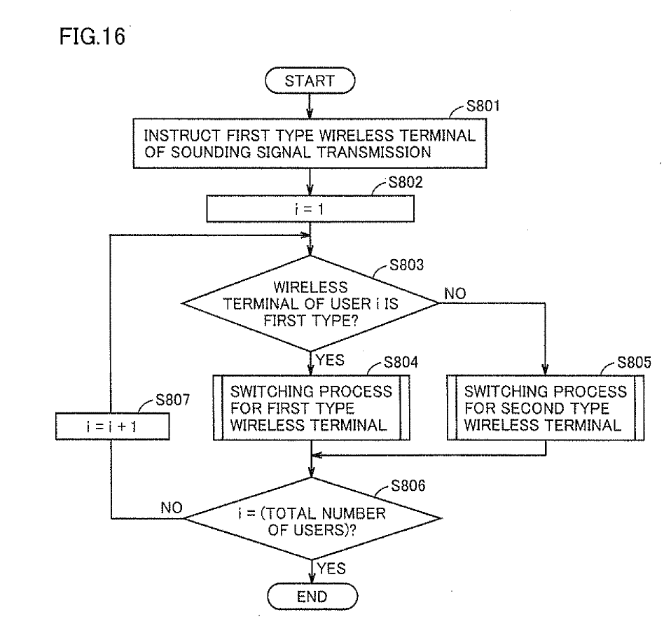

FIG. 16 is a flowchart representing an operation procedure for every one frame of the wireless communication system according to the second embodiment.

Referring to FIG. 16, sounding instruction unit 94 instructs the first type of wireless terminal to transmit a sounding signal in a downlink frame (step 801).

Then, switching unit 95 sets the user number i at 1 (step S802),

When wireless terminal 3 of user number i is the first type of wireless terminal, i.e. a wireless terminal that can transmit a sounding signal using two antennas (YES at step S803), switching unit 95 carries out the switching process for the first type of wireless terminal (step S804).

In the case where wireless terminal 3 of user number i is the second type of wireless terminal, i.e. a wireless terminal that cannot transmit a sounding signal using two antennas (NO at step S803), switching unit 95 carries out the switching process for the second type of wireless terminal (step S805).

In the case where user number i is not equal to the total number of users currently in communication (NO at step S806), switching unit 95 increments the user number i by just 1, and returns to step S803.

(Switching Process at First Type of Wireless Terminal)

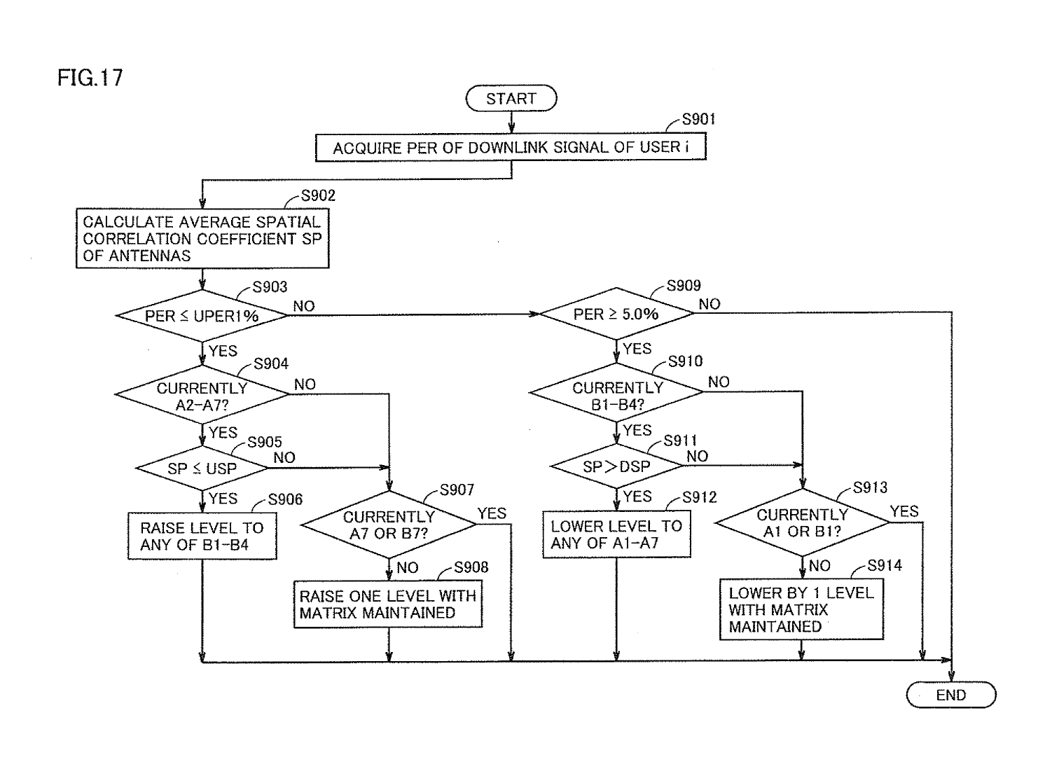

FIG. 17 is a flowchart of the detailed procedure of the operation at step S804 in the flowchart of FIG. 16.

Referring to FIG. 17, communication quality management unit 92 acquires the packet error rate PER of a downlink signal of wireless terminal 3 of user i included in the uplink frame (step S901).

Correlation coefficient calculation unit 93 calculates the spatial correlation coefficient of an uplink signal from the two antennas of wireless terminal 3 of user number i for every plurality of subcarriers in the sounding zone. Correlation coefficient calculation unit 93 calculates average spatial correlation coefficient SP that is an average of the calculated spatial correlation coefficients for all subcarriers (step S902).

In the case where packet error rate PER is less than or equal to threshold value UPER 1(%) (YES at step S903), the current communication level is A2-A7 (YES at step S904), and average spatial correlation coefficient SP is less than or equal to threshold value USP (YES at step S905), switching unit 95 raises the current communication level to any of B1-B4 in which the MATRIX is raised, according to the communication level switching rule of FIG. 13 (step S906).

In the case where packet error rate PER is less than or equal to threshold value UPER 1(%) (YES at step S903), the current communication level is not A2-A7 (NO at step S204), or average spatial correlation coefficient SP exceeds threshold value USP (YES at step S905), switching unit 95 modifies the current communication level to that having the MCS raised by one level while maintaining the MATRIX as long as the current communication level is not A7 or B7 (NO at step S908), according to the communication level switching rule of FIG. 13 (step S908).

In the case where packet error rate PER is greater than or equal to 5.0(%) (NO at step S903 and YES at step S909), the current communication level is B1-B4 (YES at step S910), and average spatial correlation coefficient SP exceeds threshold value DSP (YES at step S905), switching unit 95 lowers the current communication level to any of A2-A7 in which the MATRIX is lowered, according to the communication level switching rule of FIG. 13 (step S912).

In the case where packet error rate PER is greater than or equal to 5.0(%) (NO at step S903 and YES at step S909), the current communication level is not B1-B4 (NO at step S910), or average spatial correlation coefficient SP is less than or equal to threshold value DSP (NO at step S911), switching unit 95 modifies the communication level to that having the MCS lowered by one level while maintaining the MATRIX as long as the current communication level is not A1 or B1 (NO at step S913), according to the communication level switching rule of FIG. 13 (step S914).

(Switching Process at Second Type of Wireless Terminal)

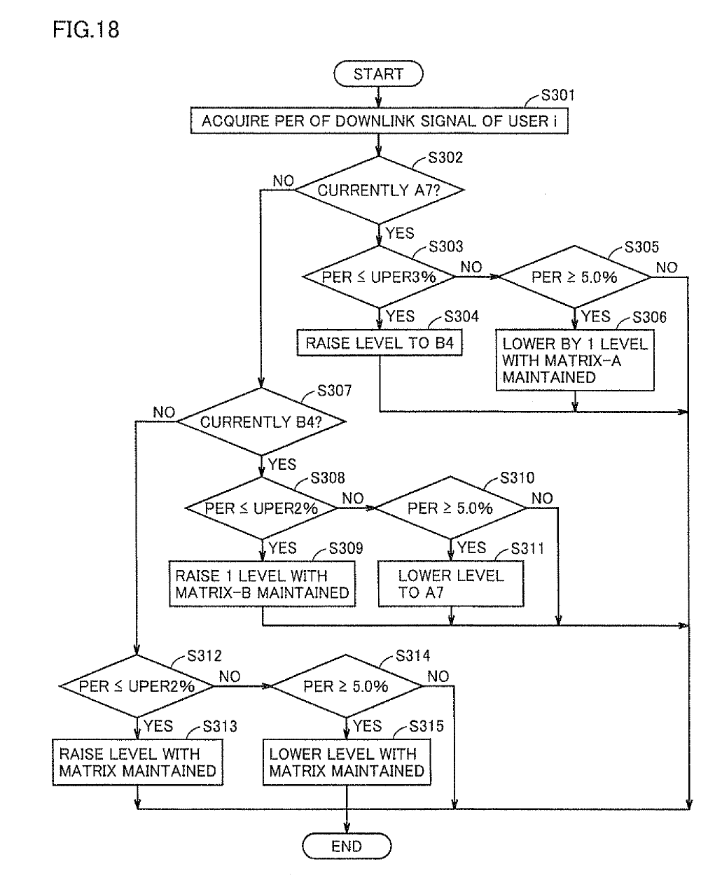

FIG. 18 is a flowchart of the detailed procedure of the operation at step S805 in the flowchart of FIG. 16.

Referring to FIG. 18, communication quality management unit 92 acquires packet error rate PER of a downlink signal of wireless terminal 3 of user i included in the uplink frame (step S301).

In the case where the current communication level is A7 (YES at step S302), and packet error rate PER is less than or equal to threshold value UPER 3(%) (YES at step S303), switching unit 95 raises the communication level to B4 in which the MATRIX is raised, according to the communication level switching rule of FIG. 14 (step S305).

In the case where the current communication level is A7 (YES at step S302), and packet error rate PER is greater than or equal to 5.0(%) (NO at step S303, YES at step S305), switching unit 95 modifies the communication level to that having the MCS lowered by one level while maintaining MATRIX-A, according to the communication level switching rule of FIG. 14 (step S306).

In the case where the current communication level is B4 (NO at step S302 and YES at step S307) and packet error rate PER is less than or equal to threshold value UPER 2(%) (YES at step S308), switching unit 95 modifies the communication level to that having the MCS raised by one level while maintaining MATRIX-B, according to the communication level switching rule of FIG. 14 (step S309).

In the case where the current communication level is B4 (NO at step S302, YES at step S307) and packet error rate PER is greater than or equal to 5.0(%) (NO at step S303, YES at step S305), switching unit 95 lowers the communication level to A7 in which the MATRIX is lowered, according to the communication level switching rule of FIG. 14 (step S311).

In the case where the current communication level is not A7 or B4 (NO at step S307, and packet error rate PER is less than or equal to threshold value UPER 2(%) (YES at step S312), switching unit 95 modifies the communication level to that having the MCS raised by one level while maintaining the MATRIX, according to the communication level switching rule of FIG. 14 (step S313).

In the case where the current communication level is not A7 and B4 (NO at step S307), and packet error rate PER is greater than or equal to 5.0(%) (NO at step S312, YES at step S314), switching unit 95 modifies the communication level to that having the MCS lowered by one level while maintaining the MATRIX, according to the communication level switching rule of FIG. 14 (step S315).

(Overview)

At the first type of wireless terminal according to the wireless communication system of the second embodiment, the MIMO scheme of a downlink signal is switched based on the packet error rate of a downlink signal and the spatial correlation coefficient of a sounding signal from the two antennas of the wireless terminals. At the second type of wireless terminal, threshold value UPER 3 of packet error rate when the MATRIX is to be raised in level is set lower than packet error rate threshold value UPER 2 of a downlink signal when the MCS is to be raised in level under the same MATRIX (that is, set to the better communication quality). Since the MATRIX is raised according to a rule corresponding to the transmission capability of a sounding signal of a wireless terminal, high throughput property and area property, as well as frequency usage efficiency can be achieved at the wireless terminal.

### Modification of Second Embodiment

The present invention is not limited to the above-described embodiment in which the values of threshold values UPER 1, USP and DSP are the same for all the wireless terminals of the first type and the values of threshold values UPER 2 and UPER 3 are identical for all the wireless terminals of the second type. A different threshold value may be used individually for each wireless terminal or for each type of wireless terminal. The type of wireless terminal can be set based on the number of antennas used in reception, the number of antennas used in transmission, the reception control scheme of the wireless terminal (whether or not an adaptive array reception function is equipped), and the like.

### Third Embodiment

The third embodiment is related to a wireless base station that can appropriately set the threshold values UPER 1, UPER 2 and UPER 3 employed in the second embodiment by learning.

(Configuration of Wireless Base Station)

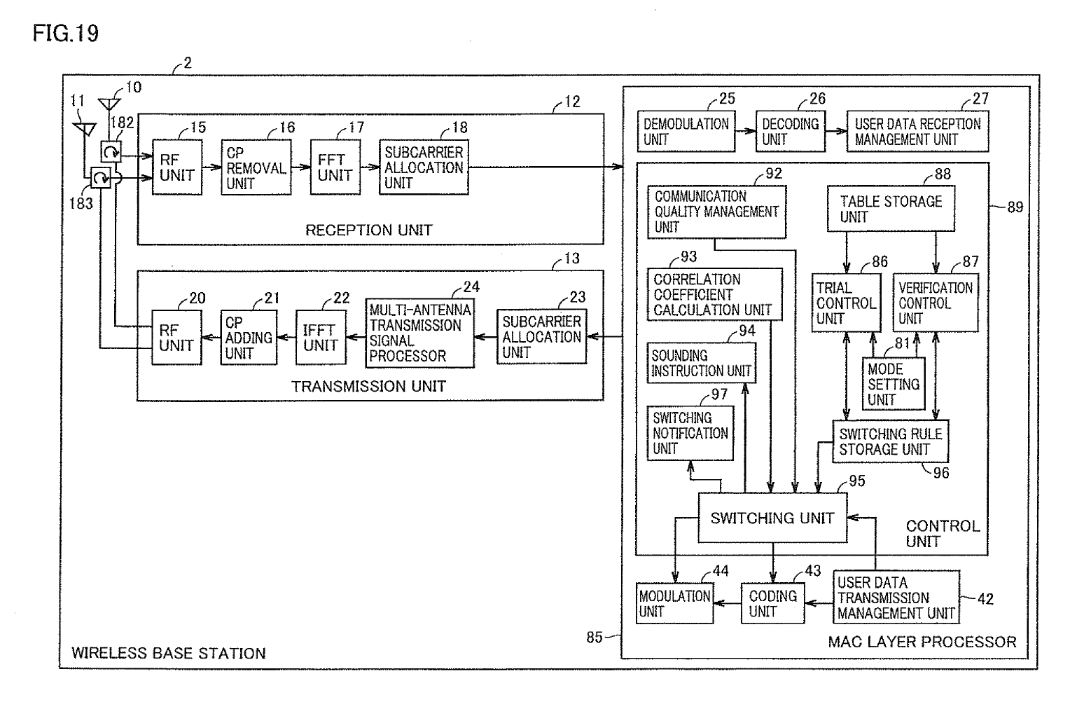

FIG. 19 represents a configuration of a wireless base station according to a third embodiment.

Referring to FIG. 19, wireless base station 2 includes, in addition to the configuration of wireless base station 2 of the second embodiment shown in FIG. 11, a table storage unit 88, a mode setting unit 81, a trial control unit 86, and a verification control unit 87.

In table storage unit 88, a switching history table and a switching success rate table are stored.

(Switching History Table)

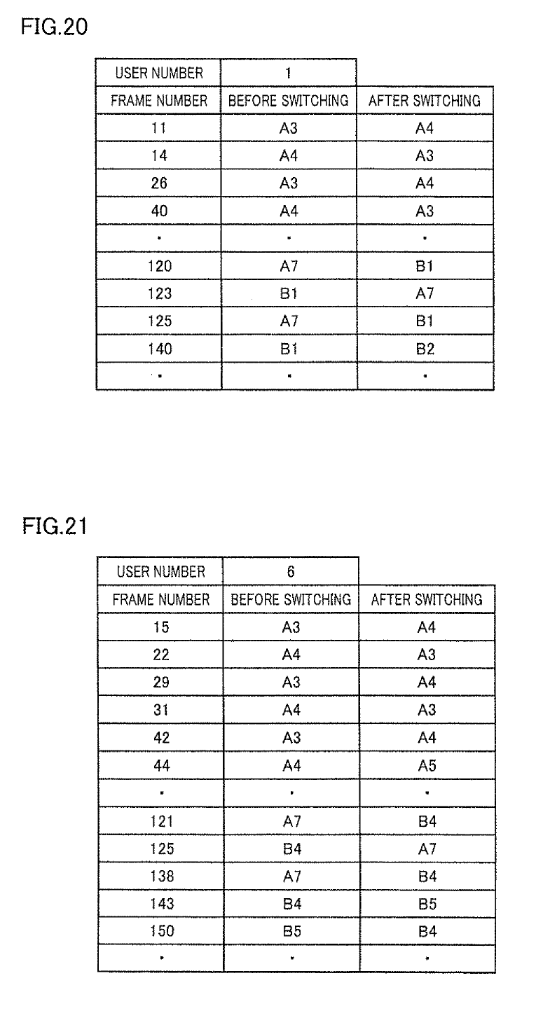

FIG. 20 represents an example of a switching history table of the first type of wireless terminal.

Referring to FIG. 20, the switching history table of the first type of wireless terminal defines a user number, the frame number when switching was effected, the communication level prior to switching, and the communication level after the switching. For example, for the wireless terminal of user number “1”, the switching of the communication level from “A3” to “A4” at frame number “11” and the switching of the communication level from “A4” to “A3” at frame number “14” are recorded.

FIG. 21 represents an example of a switching history table of the second type of wireless terminal.

Referring to FIG. 21, the switching history table of the second type of wireless terminal defines a user number, the frame number when switching was effected, the communication level prior to switching, and the communication level after the switching. For example, for the wireless terminal of user number “6”, the switching of the communication level from “A3” to “A4” at frame number “15” and the switching of the communication level from “A4” to “A3” at frame number “22” are recorded.

(Switching Success Rate Table)

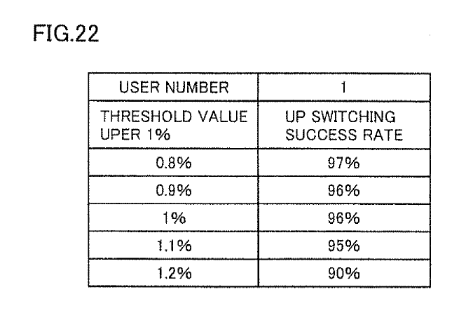

FIG. 22 represents an example of a switching success rate table of the first type of wireless terminal.

Referring to FIG. 22, the switching success rate table of the first type of wireless terminal defines a user number, and an up switching success rate corresponding to threshold value UPER 1.

As used herein, an up switching success rate represents the ratio of not being lowered to the former communication level within a predetermined number of frames after the communication level has been raised.

For example, at the wireless terminal of user number “1”, the up switching success rate is “97(%)” where threshold value UPER 1 is “0.8(%)”. This value is calculated based on the switching history table of the first type of wireless terminal corresponding to user number “1” of FIG. 20.

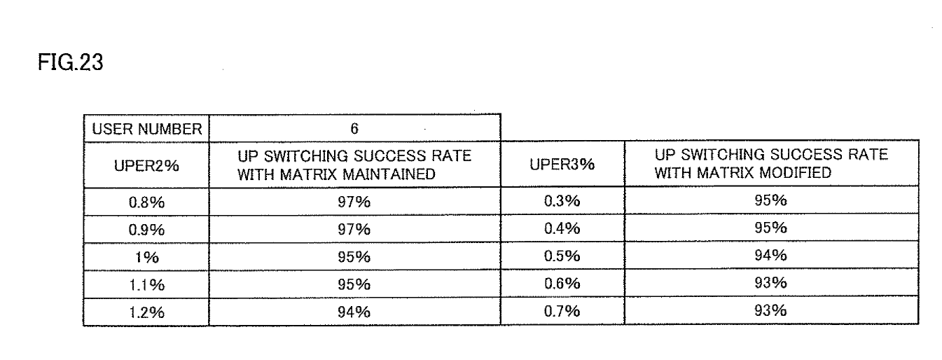

FIG. 23 represents an example of a switching success rate table of the second type of wireless terminal.

Referring to FIG. 23, the switching success rate table of the second type of wireless terminal defines a user number, the up switching success rate corresponding to threshold value UPER 2, and the up switching success rate corresponding to threshold value UPER 3. For example, at the wireless terminal of user number “6”, the up switching success rate having no modification of MATRIX is “97(%)” where threshold value UPER 2 is “0.8(%)”, and the up switching success rate accompanied by modification of MATRIX is “95(%)” where threshold value UPER 3 is “0.3(%)”. This value is calculated based on the switching history table of the second type of wireless terminal corresponding to the user number “6” of FIG. 21.

Mode setting unit 81 sets the mode of wireless communication from the normal mode to a trial mode or verification mode at a predetermined timing such as for every constant period. In the normal mode, the operation represented in the flowcharts of FIGS. 16-18 described in the second embodiment is executed.

In a trial mode, trial control unit 86 changes threshold values UPER 1, UPER 2, and UPER 3, and modifies the communication level in a manner similar to that of the second embodiment under the changed threshold values. Trial control unit 86 determines whether the up switching has succeeded or not based on whether the communication level has been lowered within a predetermined number of frames subsequent to up switching, Trial control unit 86 identifies threshold values UPER 1, UPER 2, and UPER 3 used in the normal mode based on the determination result.

In a verification mode, verification control unit 87 modifies the communication level in a manner similar to that of the second embodiment under threshold values UPER 1, UPER 2, and UPER 3 set at the normal mode. Verification control unit 87 determines whether the up switching has succeeded or not based on whether the communication level has been lowered within a predetermined number of frames subsequent to up switching. Verification control unit 87 causes mode setting unit 81 to switch to the trial mode based on the determination result.

(Operation in Trial Mode)

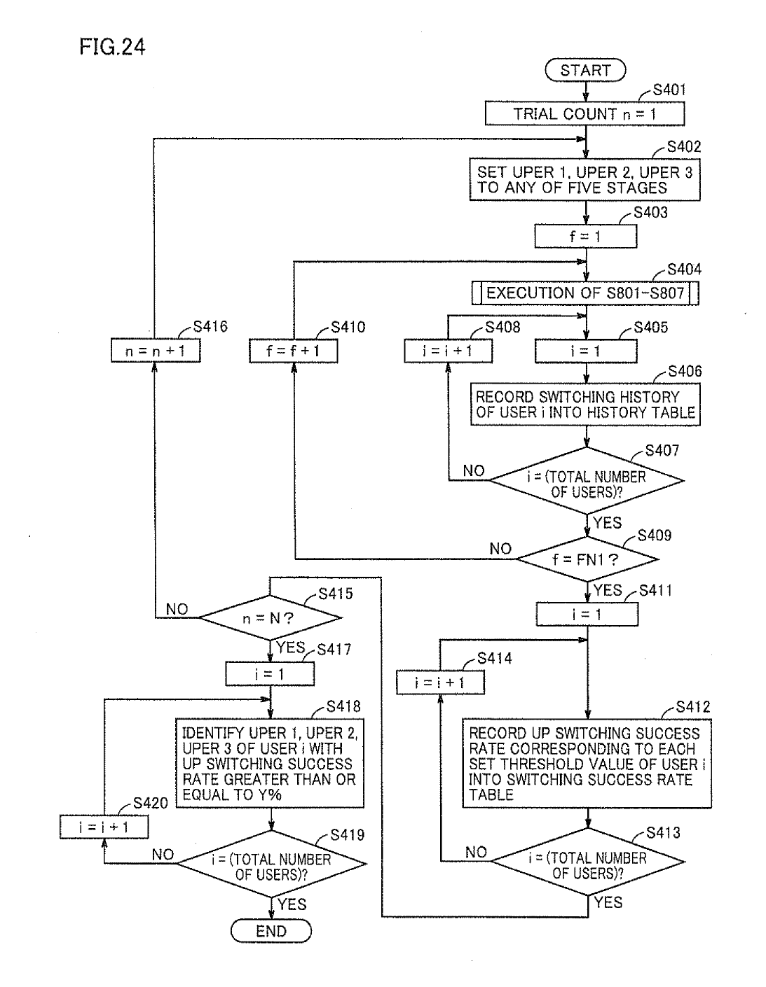

FIG. 24 represents an operation procedure in a trial mode of the wireless communication system of the third embodiment.

Referring to FIG. 24, trial control unit 86 first sets the trial count n to 1 (step S401).

Then, trial control unit 86 sets threshold values UPER 1, UPER 2, UPER 3 to any of the five stages among predetermined N stages (step S402).

Trial control unit 86 sets frame number f at 1 (step S403).

Trial control unit 86 causes wireless base station 2 to execute steps S801-S807 of FIG. 16 (step S404).

Then, trial control unit 86 sets user number i at 1 (step S405).

Trial control unit 86 records the switching history of user i in the switching history table, as shown in FIGS. 20 and 21 (step S406).

When user number i is not equal to the total number of users currently in communication (NO at step S407), trial control unit 86 increments user number i by 1 (step S408), and returns to step S406.

When user number i is equal to the total number of users in communication (YES at step S407), and frame number f is not equal to a predetermined number FN1 (NO at step S409), trial control unit 86 increments frame number f by just 1 (step S410), and returns to step S404; otherwise, when frame number f is equal to predetermined value FN1 (YES at step S409), trial control unit 86 proceeds to step S411.

At step S411, trial control unit 86 sets user number i at 1 (step S411).

Then, trial control unit 86 refers to the switching history table of user i to calculate and record into the switching success rate table, as shown in FIG. 22, the up switching success rate of the communication level relative to threshold values UPER 1, UPER 2, UPER 3 set at step S402. Specifically, when wireless terminal 3 of user i is the first type of wireless terminal, trial control unit 86 calculates the up switching success rate at threshold value UPER 1 based on the number of times the communication level has been raised, and the number of times the communication level has been lowered within a predetermined number of frames subsequent to the up switching. When wireless terminal 3 of user i is the second type of wireless terminal, trial control unit 86 calculates the up switching success rate at threshold value UPER 2 based on number of times the communication level has been raised excluding the rise from A7 to B4, and the number of times the communication level has been lowered within a predetermined number of frames subsequent to the up switching, as well as the up switching success rate at threshold value UPER 3 based on the number of times the communication level has been raised from A7 to B4, and the number of times the communication level has been lowered within a predetermined number of frames subsequent to the up switching (step S412).

Then, when user number i is not equal to the total number of users in communication (NO at step S413), trial control unit 86 increments user number i by just 1 (step S414), and returns to step S412.

When user number i is equal to the total number of users in communication (YES at step S413), and trial count n is not equal to a predetermined value N (NO at step S415), trial control unit 86 increments trial count n by just 1 (step S416), and returns to step S402; otherwise, when trial count n is equal to predetermined value N (YES at step S415), trial control unit 86 proceeds to step S417.

At step S417, trial control unit 86 sets user number i at 1 (step S417).

Trial control unit 86 refers to the switching success rate table of user i to identify threshold value UPER 1, or threshold values UPER 2 and UPER 3 of user i such that the up switching success rate becomes greater than or equal to Y (%). Specifically, when wireless terminal 3 of user i is the first type of wireless terminal, trial control unit 86 identifies threshold value UPER 1 of user i such that the up switching success rate becomes greater than or equal to Y (%). When wireless terminal 3 of user i is the second type of wireless terminal, trial control unit 86 identifies threshold value UPER 2 of user i such that the up switching success rate with the MATRIX maintained becomes greater than or equal to Y (%), and identifies threshold value UPER 3 of user i such that the up switching rate with the MATRIX modified becomes greater than or equal to Y (%) (step S418).

When user number i is not equal to the total number of users in communication (NO at step S419), trial control unit 86 increments user number i by just 1 (step S420), and returns to step S418; otherwise when user number i is equal to the total number of users in communication (YES at step S419), the operation ends.

(Operation in Verification Mode)

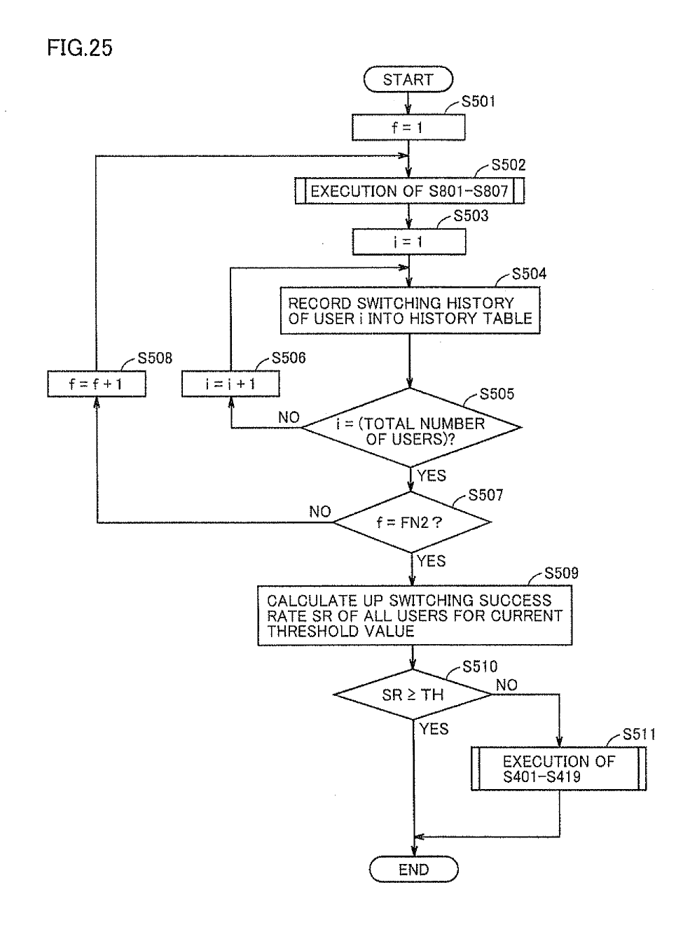

FIG. 25 represents an operation procedure in a verification mode of the wireless communication system according to the third embodiment.

Referring to FIG. 25, verification control unit 87 sets frame number f at 1 (step S501).

Then, verification control unit 87 causes wireless base station 2 to execute steps S801-S807 of FIG. 16 (step S502).

Verification control unit 87 sets user number i at 1 (step S503),

Verification control unit 87 records the switching history of user i in the history table, as shown in Figs, 20 and 21 (step S504).

When user number i is not equal to the total number of users in communication (NO at step S505), verification control unit 87 increments user number i by just 1 (step S506), and returns to step S504.

When user number i is equal to the total number of users in communication (YES at step S505), and frame number f is not equal to a predetermined number FN2 (NO at step S507), verification control unit 87 increments frame number f by just 1 (step S508), and returns to step S502; otherwise, when frame number f is equal to predetermined number FN2 (YES at step S507), verification control unit 87 proceeds to step S509.

Verification control unit 87 refers to the switching history table of user i and calculates the up switching success rate SR of the communication level for all users relative to the currently set threshold values UPER 1, UPER 2, and UPER 3 (step S509).

When switching success rate SR of all the users is below a predetermined value TH (NO at step S510), verification control unit 87 causes mode setting unit 81 to set the trial mode, and causes wireless base station 2 to carry out the trial mode process of steps S401-S420 in FIG. 24 (step S511).

In the case where the switching success rate SR of all the users is greater than or equal to predetermined value TH (YES at step S510), verification control unit 87 ends the process.

(Overview)

According to the wireless communication system of the third embodiment set forth above, the threshold value of the packet error rate to raise the communication level can be adjusted to an appropriate value for each wireless terminal according to the trial mode and verification mode.

### Fourth Embodiment

The fourth embodiment is related to a wireless base station that can modify appropriately the data burst region for the user data of a wireless terminal at MATRIX-B, when there is a wireless terminal having the downlink MIMO scheme modified to MATRIX-B. According to the MIMO scheme of MATRIX-B, the throughput property and area property, as well as the frequency usage efficiency of the wireless terminal will change depending upon which data burst region the user data is assigned to. In contrast, according to the MIMO scheme of MATRIX-A, the throughput property and area property, as well as the frequency usage efficiency of the wireless terminal do not greatly change, independent of which data burst region the user data is assigned to.

(Configuration of Wireless Base Station)

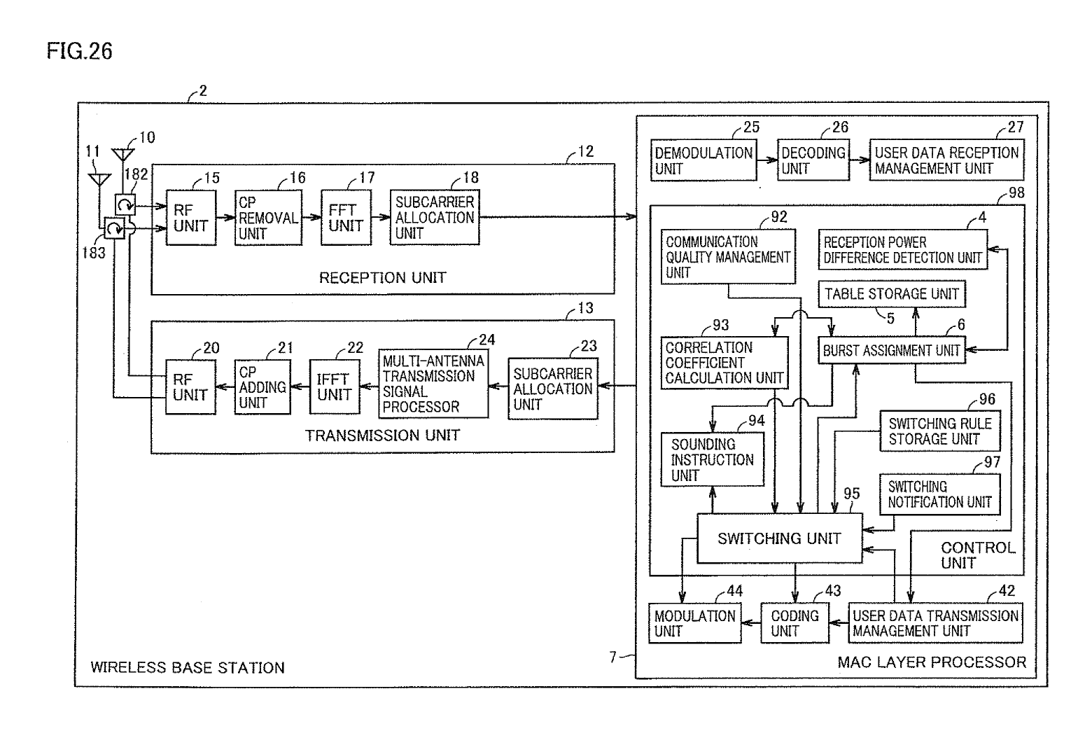

FIG. 26 represents a configuration of a wireless base station according to a fourth embodiment.

Referring to FIG. 26, wireless base station 82 includes, in addition to the configuration of wireless base station 2 of the second embodiment shown in FIG. 11, a table storage unit 5, a reception power difference detection unit 4, and a burst assignment unit 6.

In table storage unit 5, a first assignment table, a second assignment table, and a detection table are stored.

(Assignment Table)

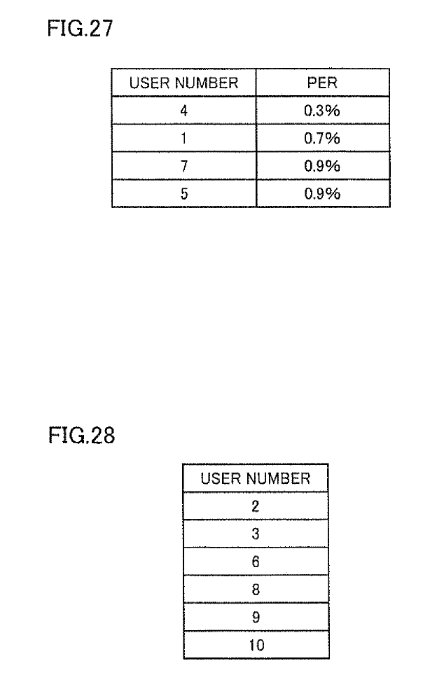

FIG. 27 represents an example of a first assignment table.

Referring to FIG. 27, the first assignment table defines the user number of the first type of wireless terminal whose downlink MIMO scheme is raised in level from MATRIX-A to MATRIX-B, and packet error rate PER of the downlink signal towards the wireless terminal of that user number.

For example, the table shows that the wireless terminal of user number 4 has the downlink MIMO scheme raised in level from MATRIX-A to MATRIX-B, and the packet error rate of a downlink signal towards the wireless terminal of user number “4” is “0.3.(%)”

FIG. 28 represents an example of a second assignment table.

Referring to FIG. 28, the second assignment table defines a user number not recorded in the first assignment table.

(Detection Table)

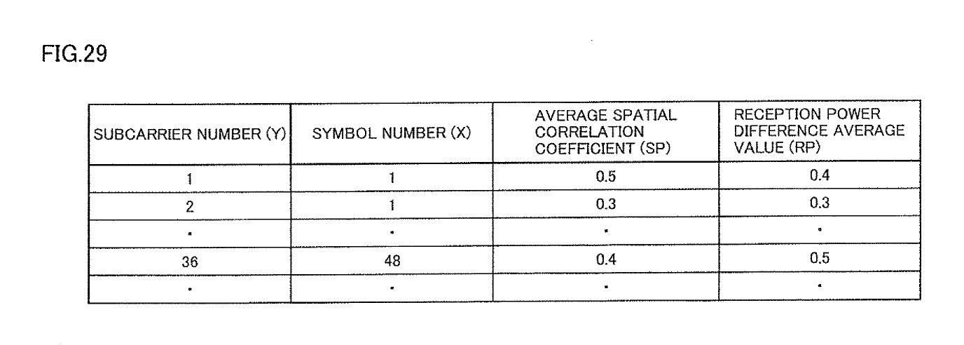

FIG. 29 represents an example of a detection table.

Referring to FIG. 29, the detection table defines a subcarrier number (Y), a symbol number (X), as well as an average spatial correlation coefficient (SP) and reception power difference average value (RP) of sounding signals from two antennas 50 and 51 of wireless terminal 3 when user data with x subcarriers and y symbols is assigned subcarrier number Y to (Y+y−1) and symbol number X to (X+x−1).

Reception power difference detection unit 4 detects the difference in reception power of sounding signals for every subcarrier from two antennas 50 and 51 of wireless terminal 3. Reception power difference detection unit 4 calculates an average value RP of the reception power difference that is the detected reception power difference averaged over a plurality of subcarriers.

Burst assignment unit 6 assigns user data to a portion of the data burst region in the downlink frame. When there is a wireless terminal whose downlink signal MIMO scheme has been modified to MATRIX-B, burst assignment unit 6 deter wines the assignment position of the user data based on the spatial correlation coefficient of a sounding signal for each subcarrier, and the reception power difference, as necessary.

(Detection Region)

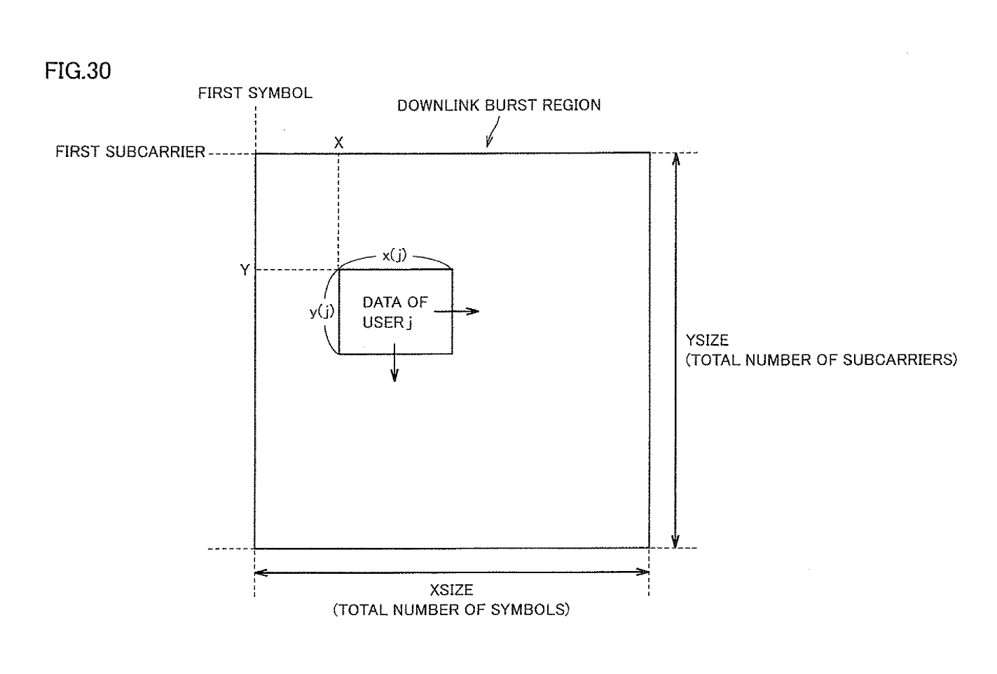

FIG. 30 is a diagram to describe the process of determining an assignment position of user data in the downlink burst region.

Referring to FIG. 30, the total number of symbols and the total number of subcarriers are XSIZE and YSIZE, respectively, in the downlink burst region. The number of symbols and the number of subcarriers in the user data of user number j are x (j) and y (j), respectively. The head symbol number in the assignment position of the user data and the head subcarrier number are X and Y, respectively. For each subcarrier number Y, one value of X allowing assignment of user data is searched for. The value of X is searched for within the range of 1 to X−x (j)+1. In the case where user data can be assigned at a certain X, average spatial correlation coefficient SP and reception power difference average value RP are detected for the purpose of determining whether the detected position is appropriate or not.

When there is no value of X allowing assignment for a certain Y, a determination is made that user data of user number j cannot be allocated at the position where the subcarrier number has Y at the head. In the case where there is no value of X that allows allocation for all Y (1≦Y≦(Y−y(j)+1), a determination is made that the user data of user number j cannot be allocated.

(Operation)

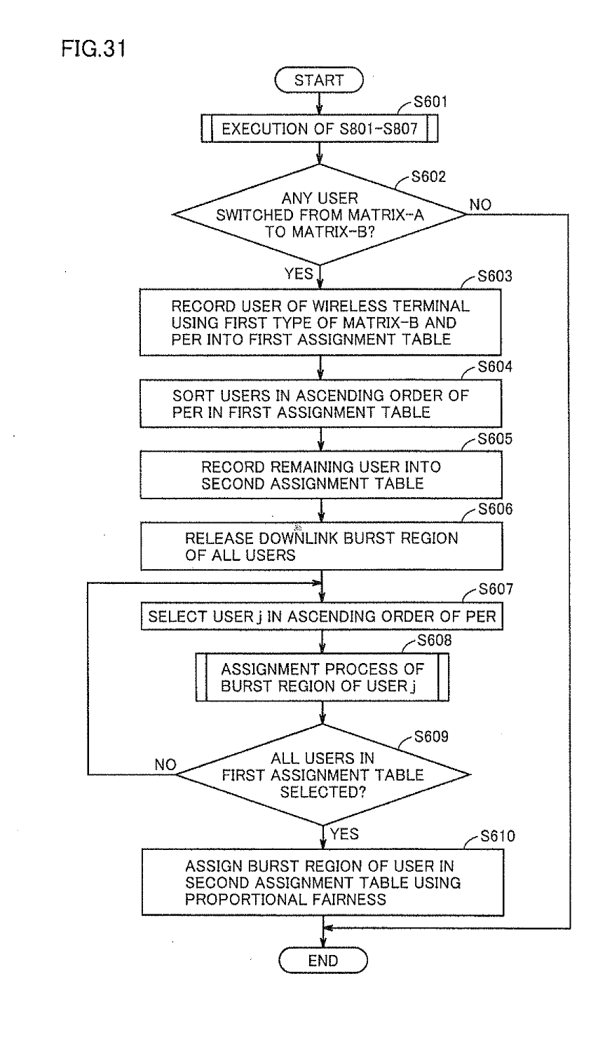

FIG. 31 is a flowchart representing an operation procedure of burst region assignment of the wireless base station of the fourth embodiment.

Referring to FIG. 31, first the process of steps S801-S807 shown in FIG. 16 is executed (step S601).

When the downlink signal MIMO scheme to wireless terminal 3 of any user is raised in level from MATRIX-A to MATRIX-B (YES at step S602), burst assignment unit 6 registers into the first assignment table the user number of the wireless terminal using MATRIX-B among the first type of wireless terminals together with packet error rate PER of a downlink signal (step S603).

Then, burst assignment unit 6 sorts the users in the first assignment table in the ascending order of packet error rate PER (step S604).

Burst assignment unit 6 registers the remaining users in communication, not registered at the first assignment table, into the second assignment table (step S605). Then, burst assignment unit 6 releases the downlink frame burst region assigned to each user (S606).

Burst assignment unit 6 selects one user at the time in the first assignment table according to the sorted order (i.e. in the order having a smaller packet error rate). The user number of the selected user is set as j (step S607).

Burst assignment unit 6 assigns the burst region to the user of user number j. The details will be described afterwards (S608).

When there is an unselected one of the users in the first assignment table(NO at step S609), burst assignment unit 6 returns to step S607.

When all the users in the first assignment table have been selected (YES at step S609), burst assignment unit 6 assigns the burst region of the users in the second assignment table using proportional fairness (step S610).

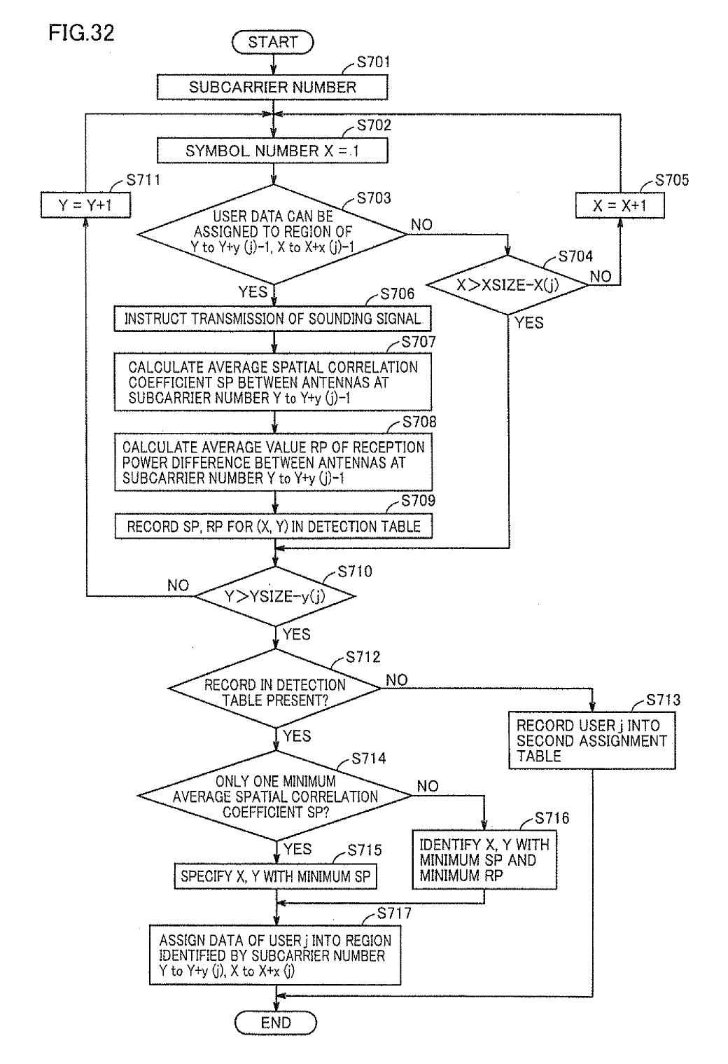

FIG. 32 is a flowchart representing the detailed procedure of the operation at step S608 in the flowchart of FIG. 31. In FIG. 32, x (j) represents the number of symbols in the user data of user number j, and y (j) represents the number of subcarriers in the user data of user number j.

Referring to FIG. 32, burst assignment unit 6 first sets subcarrier number Y at 1 (step S701).

Then, burst assignment unit 6 sets symbol number X at 1 (step S702).

When the user data of user number j can be assigned to the region specified by a subcarrier number Y to Y+y (j)−1 and a symbol number X to X+x (j)−1 in the downlink frame burst region, i.e. in the case where the specified region is not yet assigned and is present (YES at step S703), burst assignment unit 6 instructs sounding instruction unit 94 to transmit an instruction to wireless terminal 3 of user number j for transmission of a sounding signal (step S706).

Then, burst assignment unit 6 causes correlation coefficient calculation unit 93 to calculate the spatial correlation coefficient of sounding signals from two antennas 50 and 51 of wireless terminal 3 of user number j at each subcarrier in the region of subcarrier number Y to subcarrier number Y+y (j)−1, and to further calculate an average spatial correlation coefficient SP that is the average of the spatial correlation coefficients over all the subcarriers included in the relevant region (step S707).

Burst assignment unit 6 causes reception power difference detection unit 4 to detect the difference in reception power of sounding signals from two antennas 50 and 51 of wireless terminal 3 of user number j at each subcarrier in the region of subcarrier number Y to subcarrier number Y+y−1, and to further calculate a reception power difference average value RP that is the reception power differences averaged over all the subcarriers included in the relevant region (step S708).

Burst assignment unit 6 records average spatial correlation coefficient SP and reception power difference average value RP corresponding to subcarrier number X and symbol number Y into a detection table, as shown in FIG. 29, and proceeds to step S710 (step S709).

When the user data of user number j cannot be assigned to the position specified by subcarrier number Y and symbol number X in the downlink frame burst region (NO at step S703), and symbol number X is less than or equal to a value of the number of symbol XSIZE in the downlink frame burst region minus the number of symbols x (j) in the user data of user number j (NO at step S704), burst assignment unit 6 increments symbol number X by just 1 (step S705), and returns to step S702.

When the user data of user number j cannot be assigned to the position specified by subcarrier number Y and symbol number X in the downlink frame burst region (NO at step S703), and symbol number X is greater than the value of the number of symbol XSIZE in the downlink frame burst region minus the number of symbols x (j) in the user data of user number j (YES at step S704), burst assignment unit 6 determines that assignment of the user data of user number j at subcarrier number Y is not possible, and proceeds to step S710.

At step S710, when subcarrier number Y is less than or equal to the value of subcarrier number YSIZE in the downlink frame burst region minus subcarrier number y (j) in the user data of user number j (NO at step S710), burst assignment unit 6 increments subcarrier number Y by just 1 (step S711), and returns to step S702.

When subcarrier number Y is greater than the value of subcarrier number YSIZE in the downlink frame burst region minus subcarrier number y (j) in the user data of user number j (YES at step S710), burst assignment unit 6 proceeds to the next step S712.

When data is not recorded in the detection table (NO at step S712), burst assignment unit 6 determines that assignment of the user data of user number j is not possible, and records the user of user number j into the second assignment table (step S713).

When data is recorded in the detection table (YES at step S712), burst assignment unit 6 refers to the detection table to identify whether there is only one minimum average spatial correlation coefficient SP.

In the case there is only one minimum average spatial correlation coefficient SP (YES at step S714), burst assignment unit 6 identifies the subcarrier number Y and symbol number X corresponding to the minimum average spatial correlation coefficient SP (step S715).

In the case where there are two or more minimum average spatial correlation coefficients SP (NO at step S714), burst assignment unit 6 identifies the subcarrier number Y and symbol number X that has the minimum average spatial correlation coefficient SP and the minimum reception power difference average value RP (step S716).

Then, burst assignment unit 6 assigns the user data of user j into the region specified by subcarrier number Y to Y+y (j), and symbol number X to X+x (j) in the downlink frame burst region (step S717).

(Overview)

According to the wireless communication system of the fourth embodiment, when there is the first type of wireless terminal having the downlink MIMO scheme modified to MATRIX-B, the allocation of the user data in the downlink burst region is determined based on the spatial correlation coefficient of the sounding signal for each subcarrier transmitted from the two antennas of that wireless terminal and the reception power difference, as necessary. Accordingly, spatial multiplexed downlink signals can be transmitted at the optimum frequency (subcarrier) on part of the wireless base station. Therefore, high throughput property and area property, as well as high frequency usage efficiency, can be achieved at the wireless terminal.

(Modification)

The present invention is not limited to the above-described embodiments, and may include modifications set forth below.

(1) Collaborative Spatial Multiplex Mode

The present invention is not limited to the first embodiment in which two wireless terminals are taken as one set for the collaborative spatial multiplex mode. Three or more wireless terminals may be taken as one set for the collaborative spatial multiplex mode.

(2) STC Base

The present invention is not limited to the first embodiment in which the uplink signal of user data is transmitted through a communication scheme using a single antenna in the communication scheme other than the collaborative spatial multiplex. The uplink signal of user data may be transmitted through a communication scheme of the STC-based type, in addition to or as an alternative to the communication system using a single antenna,

(3) Reception Power Difference

The first embodiment of the present invention was described in which the throughput calculation unit calculates the throughput when the difference in reception power of uplink signals from two wireless terminals constituting a pair can be set to 0 dB among the candidate pairs for the collaborative spatial multiplex mode. The throughput may be calculated when the reception power difference is less than a predetermined value.

(4) Candidate Terminal

The present invention is not limited to the first embodiment in which a wireless terminal not currently set at the collaborative spatial multiplex mode, and having the MCS of the highest transmission data rate among the MCS of uplink signals of all wireless terminals in the communication party is set as a candidate terminal for the collaborative spatial multiplex mode. For example, a wireless terminal not currently set at the collaborative spatial multiplex mode among all the plurality of wireless terminals in the communication party may be set as the candidate terminal.

(5) Lowered in Level

The present invention is not limited to the first embodiment in which, when average spatial correlation coefficient M_SR is below threshold value TH2 (TH1<TH2), the MCS of the wireless terminal of user X corresponding to the case where the uplink signal is to be subjected to collaborative spatial multiplex is provisionally set at a level lowered by 1 level than the MCS of the wireless terminal of user X corresponding to the case where the uplink signal is not to be subjected collaborative spatial multiplex, and the MCS of the wireless terminal of user Y corresponding to the case where the uplink signal is to be subjected to collaborative spatial multiplex is provisionally set at a level lowered by 1 level than the MCS of the wireless terminal of user Y corresponding to the case where the uplink signal is not to be subjected collaborative spatial multiplex, at step S208 in FIG. 10. The level of the MCS to be lowered may be more than 1 such as a predetermined number of 2, 3 or the like.

(6) Reception Response Vector, Spatial Correlation Coefficient

The way of calculating the reception response vector of equations (1)-(4) and the way of calculating the spatial correlation coefficient of equation (5) described in the first embodiment of the present invention is only a way of example. They may be calculated according to another way.

(7) Wireless Terminal

The present invention is not limited to the first embodiment in which the wireless terminal transmits an uplink signal from only one antenna. The wireless terminal may transmit an uplink signal from a plurality of antennas through the MIMO scheme based on STC and the like, and carrying out collaborative spatial multiplexing with another wireless terminal.

(8) Sounding Signal

In the first embodiment of the present invention, the reception response vector and the spatial correlation coefficient of sounding signals from two wireless terminals are obtained. The sounding signal is an example of a known signal. The reception response vector and spatial correlation coefficient of another type of known signal may be obtained instead,

(9) Burst Region Under a Situation of Collaborative Spatial Multiplex

The present invention is not limited to the first embodiment in which, as described in FIG. 6, when the uplink signal from wireless terminal 3 of user A and the uplink signal from wireless terminal 3 of user B are subjected to collaborative spatial multiplex, wireless terminal 3 of user A and user B uses data burst region 151 assigned to wireless terminal 3 of user A not subjected to collaborative spatial multiplex and data burst region 152 assigned to wireless terminal 3 of user B not subjected to collaborative spatial multiplex.

For example, data burst region 152 shown in FIG. 6 may be moved to a region adjacent to data burst region 151 (i.e. a region with a subsequent subchannel) and rearrange the burst regions of user E to user J, subsequent to the moved data burst region 152.

(10) Shift from Verification Mode to Trial Mode

The third embodiment of the present invention was described in which the up switching success rate of all users (all wireless terminals in communication) is calculated according to the flowchart of FIG. 25. The up switching success rate may be calculated for each user (wireless terminal), or for each type of user (wireless terminal), and cause the relevant user or the relevant type of user to shift to the trial mode when the up switching success rate is below the predetermined value.

(11) Switching Success Rate in Trial Mode

The present invention is not limited to the second to fourth embodiments in which, for the first type of wireless terminal, the packet error rate threshold value UPER 1 corresponding to the case where the communication level is to be raised is set identical in every communication level. A threshold value UPER 1 differing for every communication level may be used.

Similarly, the present invention is not limited to the second to fourth embodiments in which, for the second type of wireless terminal, the packet error rate threshold value UPER 2 corresponding to the case where the communication level is to be raised, excluding the rise from A7 to B4, is set identical in every communication level.

The up switching success rate may be calculated for each communication level in the trial mode and verification mode. In the trial mode, threshold values UPER 1 and UPER 2 may be set for each communication level based on the up switching success rate for each communication level. In the verification mode, the communication level that must have threshold values UPER 1 and UPER 2 set again in the trial mode may be identified, based on the up switching success rate for every communication level.

(12) Communication Quality of Downlink Signal

In the second to fourth embodiments of the present invention, the packet error of a downlink signal was employed for the communication quality of the downlink signal. The packet error rate is transmitted in an uplink frame from a wireless terminal to a wireless base station. The present invention is not limited thereto. An index value similar to the packet error rate of a downlink signal may be calculated on part of the wireless base station by obtaining the rate of a NACK (Negative ACKnowledgement) signal being transmitted from a wireless terminal in the processing of an automatic repeat request (ARQ) or a hybrid automatic repeat request (HARQ).

(13) Sounding Signal

In the second to fourth embodiments of the present invention, the reception response vector and spatial correlation coefficient of sounding signals from two antennas of the wireless terminal are obtained. A sounding signal is an example of a known signal. The reception response vector and spatial correlation coefficient of another type of known signal may be obtained instead. Moreover, the first type of wireless terminal may be a wireless terminal that can transmit a known signal such as a sounding signal simultaneous to each other or at a different time, from three or more wireless terminals, instead of two antennas.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 wireless communication system; 2 wireless base station; 3, 3a-3n wireless terminal; 4 reception power difference detection unit; 5, 88 table storage unit; 6 burst assignment unit; 10, 11, 50, 51 antenna; 12, 52 reception unit; 13, 53 transmission unit; 7, 14, 54, 78, 84, 85 MAC layer processor; 15, 20, 55, 60 RF unit; 16, 56 CP removal unit; 17, 57 FFT unit; 18, 23, 58, 63 subcarrier allocation unit; 19, 59 multi-antenna reception signal processor; 21, 61 CP adding unit; 22, 62 IFFT unit; 24 multi-antenna transmission signal processor; 25, 65 demodulation unit; 26, 66 decoding unit; 27, 67 user data reception management unit; 28 communication quality measurement unit; 29, 71 MCS setting unit; 30, 81 mode setting unit; 31 candidate selection unit; 32 throughput calculation unit; 33, 93 correlation coefficient calculation unit; 34 power difference measurement unit; 35 table generation unit; 36 terminal setting unit; 37 terminal control unit; 38 MCS notification unit; 39 power control unit; 40 sounding transmission instruction unit; 41 burst region notification unit; 42, 72 user data transmission management unit; 43, 73 coding unit; 44, 74 modulation unit; 8, 64, 89, 91, 98 control unit; 68 burst region management unit; 69 power control unit; 70 sounding signal output unit ; 75 communication quality measurement unit; 76 sounding output unit; 77 MIMO management unit; 79 MCS management unit; 86 trial control unit; 87 verification control unit; 92 communication quality management unit; 94 sounding instruction unit ; 95 switching unit; 96 switching rule storage unit; 97 switching notification unit; 151, 152 data burst region; 182, 183, 282, 283 couple/distributor.

1. A wireless base station communicating with a plurality of wireless terminals transmitting an uplink signal, comprising:
a plurality of antennas,
a mode setting unit setting two or more wireless terminals at a collaborative spatial multiplex mode in which an identical uplink data burst region is shared for usage, based on throughput of uplink signals from a plurality of wireless terminals,
a region notification unit notifying said two or more wireless terminals set at the collaborative spatial multiplex mode of the uplink data burst region shared among said two or more wireless terminals for usage, and
a reception unit separating uplink signals received through said plurality of antennas and spatial multiplexed at the shared uplink data burst region from said two or more wireless terminals set at the collaborative spatial multiplex mode to extract a signal from each wireless terminal.

2. The wireless base station according to claim I, wherein said mode setting unit includes
a candidate selection unit selecting a candidate terminal from a plurality of wireless terminals that becomes a candidate for being set at the collaborative spatial multiplex mode,
a throughput calculation unit establishing a pair from said selected candidate terminals and calculating a sum of throughput of uplink signals from all wireless terminals of a communication party when the wireless terminals constituting said pair are set at the collaborative spatial multiplex mode, and
a terminal setting unit identifying the pair that has a maximum sum of throughput calculated when set at the collaborative spatial multiplex mode, and setting said identified pair of wireless terminals at the collaborative spatial multiplex mode.

3. The wireless base station according to claim 1, wherein said mode setting unit includes
a candidate selection unit selecting a candidate terminal from a plurality of wireless terminals that becomes a candidate for being set at the collaborative spatial multiplex mode,
a power control unit establishing a pair from said selected candidate terminals and instructing one or both of the wireless terminals constituting said pair to adjust transmission power such that a difference in reception power of uplink signals of the wireless terminals constituting said pair is less than a predetermined value,
a power difference measurement unit measuring a difference in reception power of uplink signals of the wireless terminals constituting said pair, after instructing adjustment of said transmission power,
a throughput calculation unit calculating a sum of throughput of uplink signals from all wireless terminals of a communication party when wireless terminals constituting a pair having said difference in reception power less than or equal to the predetermined value are set at the collaborative spatial multiplex mode, and
a terminal setting unit identifying a pair that has a maximum sum of throughput calculated when set at said collaborative spatial multiplex mode, and setting said identified pair of wireless terminals at the collaborative spatial multiplex mode.

4. The wireless base station according to claim 3, further comprising
a correlation coefficient calculation unit calculating a spatial correlation coefficient of known signals from the wireless terminals constituting said pair,
wherein said throughput calculation unit identifies an MCS (modulation and code scheme) when the uplink signals of the wireless terminals constituting said pair are spatial multiplexed based on said spatial correlation coefficient, and calculating the throughput of uplink signals from the two wireless terminals constituting said pair based on said identified MCS.

5. The wireless base station according to claim 1, wherein said mode setting unit comprises
a candidate selection unit selecting a candidate terminal among a plurality of wireless terminals that becomes a candidate for being set at the collaborative spatial multiplex mode,
a correlation coefficient calculation unit establishing a pair from said selected candidate terminals to calculate a spatial correlation coefficient of known signals from the wireless terminals constituting said pair,
a throughput calculation unit calculating a sum of throughput of uplink signals from all wireless terminals of a communication party when two wireless terminals constituting a pair having said spatial correlation coefficient below a first threshold value are set at the collaborative spatial multiplex mode, and
a terminal setting unit identifying a pair that has a maximum sum of throughput calculated when set at said collaborative spatial multiplex mode, and setting the wireless terminals of said identified pair at the collaborative spatial multiplex mode.

6. The wireless base station according to claim 5, wherein said throughput calculation unit calculates throughput of uplink signals from the wireless terminals constituting said pair corresponding to a situation in which the MCS of uplink signals from wireless terminals constituting a pair having said spatial correlation coefficient that is greater than or equal to a second threshold value and below said first threshold value is reduced by a predetermined number of levels than the MCS when not set at said collaborative spatial multiplex mode, and calculates throughput of uplink signals from the wireless terminals constituting said pair corresponding to a situation in which the MCS of uplink signals from wireless terminals constituting a pair having said spatial correlation coefficient below said second threshold value is made to confirm to the MCS when not set at the collaborative spatial multiplex mode.

7. The wireless base station according to claim 6, further comprising:
an MCS setting unit setting the MCS of uplink signals from a wireless terminal set at the collaborative spatial multiplex mode to the MCS used in said throughput calculation, and
an MCS notification unit notifying a wireless terminal at said collaborative spatial multiplex mode of said set MCS.

8. The wireless base station according to claim 7, further comprising a communication quality measurement unit measuring communication quality of an uplink signal from said wireless terminal,
wherein said MCS setting unit sets the MCS of an uplink signal from said wireless terminal based on the communication quality of an uplink signal from said wireless terminal.

9. The wireless base station according to claim 6, further comprising
a communication quality measurement unit measuring the communication quality of an uplink signal from said wireless terminal, and
an MCS setting unit setting the MCS of an uplink signal from said wireless terminal based on the communication quality of the uplink signal from said wireless terminal.

10. The wireless base station according to claim 9, wherein said candidate selection unit identifies the MCS having a highest transmission data rate from the MCS of uplink signals of all wireless terminals of the communication party, and selects said candidate terminal from a plurality of wireless terminals having said identified MCS.

11. The wireless base station according to claim 5, wherein said candidate selection unit selects a wireless terminal not set currently at the collaborative spatial multiplex mode, among all wireless terminals of a communication party, as said candidate terminal.

12. The wireless base station according to claim 5, wherein
said throughput calculation unit further calculates the sum of throughput of uplink signals from all wireless terminals of the communication party when said candidate terminal is not set at the collaborative spatial multiplex mode, and
for wireless terminals constituting a pair that has the maximum sum of throughput of uplink signals from all wireless terminals when set at said collaborative spatial multiplex mode, said terminal setting unit sets the wireless terminals at said collaborative spatial multiplex mode only in a case where the sum of throughput of uplink signals from all wireless terminals of the communication party is greater when set at the collaborative spatial multiplex mode than when not set at the collaborative spatial multiplex mode.

13. A wireless base station transmitting a downlink signal to a wireless terminal through a plurality of antennas, said wireless base station comprising:
a plurality of antennas,
a quality management unit acquiring or calculating communication quality of a downlink signal at a wireless terminal,
a correlation calculation unit calculating a spatial correlation coefficient of known signals from a plurality of antennas of said wireless terminal,
a switching unit switching a setting of an MIMO scheme of said downlink signal from a space-time coding type to a spatial multiplex type, or from said spatial multiplex type to said space-time coding type, and
a transmission unit subjecting one data stream to space-time coding for output to said plurality of antennas when said set MIMO scheme is said space-time coding type, and subjecting a plurality of data streams to spatial multiplexing for output to said plurality of antennas, when said set MIMO scheme is said spatial multiplex type,
wherein said switching unit switches the MIMO scheme of a downlink signal from said space-time coding type to said spatial multiplex type for a first type of wireless terminal transmitting a known signal from a plurality of antennas, when said communication quality and said spatial correlation coefficient satisfy a predetermined condition.

14. The wireless base station according to claim 13, further comprising a burst assignment unit determining an allocation of user data in a data burst region of a downlink frame transmitted from the wireless base station,
wherein, when there is a wireless terminal having the MIMO scheme of a downlink signal modified to said spatial multiplex type by said switching unit, said burst assignment unit determines the allocation of user data in said data burst region based on the spatial correlation coefficient of a known signal transmitted from the plurality of antennas of said wireless terminal, for a wireless terminal whose MIMO scheme of a downlink signal is said spatial multiplex type among said first type of wireless terminals.

15. The wireless base station according to claim 13, wherein said condition for switching said MIMO scheme of a downlink signal from said space-time coding type to said spatial multiplex type is determined individually for each wireless terminal.

16. The wireless base station according to claim 13, further comprising a mode setting unit setting a mode of wireless communication from a normal mode to a trial mode at a predetermined timing, and
a trial control unit modifying, in said trial mode, the condition for said communication quality for switching said MIMO scheme of a downlink signal from said space-time coding type to said spatial multiplex type, and based on said modified condition for communication quality, switching said MIMO scheme of a downlink signal from said space-time coding type to said spatial multiplex type, and after switching to said spatial multiplex type, determining whether switching has succeeded or not based on whether said spatial multiplex type is maintained for a predetermined period,
wherein said trial control unit sets, based on a result of the determination, said condition for communication quality to be used in said normal mode.

17. The wireless base station according to claim 16, wherein said mode setting unit sets the mode of said wireless communication from the normal mode to the verification mode at a predetermined timing,
said wireless base station comprising a verification control unit switching, in said verification mode, the MIMO scheme of a downlink signal from said space-time coding type to said spatial multiplex type based on said condition for communication quality for switching said MIMO scheme of a downlink signal set at said normal mode from said space-time coding type to said spatial multiplex type, and after switching to the spatial multiplex type, determining whether switching has succeeded or not based on whether said spatial multiplex type is maintained for a predetermined period,
wherein said verification control unit causes said mode setting unit to shift to a trial mode based on a result of said determination.

18. A wireless base station transmitting a downlink signal to a wireless terminal through a plurality of antennas, said wireless base station comprising:
a plurality of antennas,
a quality management unit acquiring or calculating communication quality of a downlink signal at a wireless terminal,
a switching unit switching a setting of an MIMO scheme of a downlink signal from a space-time coding type to a spatial multiplex type, or from said spatial multiplex type to said space-time coding type, and
a transmission unit subjecting one data stream to space-time coding for output to said plurality of antennas when said set MIMO scheme is said space-time coding type, and subjecting a plurality of data streams to spatial multiplexing for output to said plurality of antennas, when said set MIMO scheme is said spatial multiplex type,
wherein said switching unit switches, for a wireless terminal other than a first type of wireless terminal transmitting a known signal from a plurality of antennas, said MIMO scheme of a downlink signal from said space-time coding type to said spatial multiplex type when the condition for communication quality, higher than the condition for communication quality when the MCS (modulation and code scheme) is raised by one level under the same MIMO scheme, is satisfied.

19. The wireless base station according to claim 18, further comprising
a mode setting unit setting a mode of wireless communication from a normal mode to a trial mode at a predetermined timing, and
a trial control unit modifying, in said trial mode, the condition for said communication quality for switching the MIMO scheme of a downlink signal from said space-time coding type to said spatial multiplex type, and, based on the modified condition for communication quality, switching said MIMO scheme of a downlink signal from said space-time coding type to said spatial multiplex type, and after switching to said spatial multiplex type, determining whether switching has succeeded or not based on whether said spatial multiplex type is maintained for a predetermined period,
wherein said trial control unit sets, based on a result of the determination, said condition for communication quality to be used in said normal mode.

20. The wireless base station according to claim 19, wherein said mode setting unit sets said mode of wireless communication from the normal mode to a verification mode at a predetermined timing,
said wireless base station comprising a verification control unit switching, in said verification mode, said MIMO scheme of a downlink signal from said space-time coding type to said spatial multiplex type, based on said condition for communication quality for switching said MIMO scheme of a downlink signal set at said normal mode from said space-time coding type to said spatial multiplex type, and after switching to said spatial multiplex type, determining whether switching has succeeded or not based on whether said spatial multiplex is maintained for a predetermined period,
wherein said verification control mode causes said mode setting unit to shift to a trial mode based on a result of said modification.
